(19) United States
(12) Patent Application Publication
(10) Pub. No.: US 2025/0225452 A1
(43) Pub. Date: Jul. 10, 2025

(54) SYSTEM AND METHOD FOR ENHANCING EFFECTIVENESS OF A COACHING SESSION OF AN AGENT BY CREATING THE COACHING SESSION BASED ON A CALCULATED COACHING IMPACT SCORE OF COACHES, IN A CONTACT CENTER

(71) Applicant: NICE LTD., Ra'anana (IL)

(72) Inventors: Amol ANWADE, Tathawade (IN); Mahesh BAIRAGI, PCMC Pune (IN); Vinayak KAVISKAR, Pune (IN); Somnath BHAMBURE, Pune (IN)

(21) Appl. No.: 18/403,788

(22) Filed: Jan. 4, 2024

(51) Int. Cl. G06Q 10/0631; G06F 40/40; G06Q 10/0633

(52) U.S. Cl. CPC G06Q 10/063112; G06F 40/40; G06Q 10/0633

(57) ABSTRACT

A computerized-method for enhancing effectiveness of a coaching-session of an agent by creating the coaching-session based on a calculated coach-impact score of coaches, in a contact center. The computerized-method includes: (i) collecting coaching-feedback-data that has been received from the agent for a plurality of coaching sessions; (ii) filtering bias from the coaching-feedback-data by removing bias therefrom; (iii) operating a coach evaluation module based on the filtered coaching-feedback-data, to yield an effective-feedback score, an associated dynamic-weightage and a coaching-effectiveness score for each coach for the selected focus area and related behavior; (iv) calculating a coach-impact score for each coach in the plurality of coaches by operating a coaching impact score module on the yielded effective-feedback score, the associated dynamic-weightage and the coaching-effectiveness score of the coach; and (v) configuring a UI to selectively display a subset of the plurality of coaches based on the calculated coach-impact score of each coach.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

The present disclosure relates to the field of data analysis and more specifically, to computerized systems and methods for enhancing effectiveness of a coaching session of a coachee by creating the coaching session based on a calculated coaching impact score of coaches, in a contact center.

### BACKGROUND

The effectiveness of a coaching session depends on the participants, the coaching content, and the coach. Current solutions focus on results of a coaching session rather than providing insights as to the effectiveness of the coaching session. The coach who acts as catalysts for agent growth, enabling them to reach their full potential and achieve better results, is often missed from these insights. However, a suitable coach may bring valuable insights and strategies to the coaching session that align with the organization's objectives, leading to improved performance and increased productivity and engagement among employees.

Therefore, there is a need for a technical solution that will improve coaching management systems and leverage the coach expertise such that employees will enhance their abilities by identifying and evaluating a coach impact on a coaching session that has been created for a specific focus area and related behaviors. Furthermore, there is a need for a technical solution that will improve coaching management systems and will provide an active assessment of abilities of a coach to train a created coaching session for the focus area and related behaviors for training purposes of the coach to improve the coach impact on such a coaching session.

### SUMMARY

There is thus provided, in accordance with some embodiments of the present disclosure, a computerized-method for enhancing effectiveness of a coaching session of an agent by creating the coaching session based on a calculated coach impact score of coaches, in a contact center.

In accordance with some embodiments of the present disclosure, the computerized method may include: (i) receiving coaching feedback data, via a coaching web application, from the agent after each coaching session that the agent has participated in. The coaching feedback data is about the coaching session and a related coach; (ii) receiving a request from a user, via a User Interface (UI) that is associated to the coaching web application, to create a new coaching session to the agent for a selected focus area and related behaviors; (iii) collecting the coaching feedback data that has been received from the agent for a plurality of coaching sessions that have been conducted during a preconfigured period. The collected feedback data includes for each coaching session at least one of: (a) set of coaching ratings; and (b) coaching comment, and each coaching session in the plurality of coaching sessions has been conducted by a different coach; (iv) filtering bias from the coaching feedback data by removing bias therefrom to yield filtered coaching feedback data; (v) operating a coach evaluation module based on the filtered coaching feedback data, to yield an effective-feedback score an associated dynamic weightage, and a coaching effectiveness score for each coach for the selected focus area and related behavior during the preconfigured period; (vi) calculating a coach impact score for each coach in the plurality of coaches by operating a coaching impact score module on the yielded effective-feedback score the associated dynamic weightage and the coaching effectiveness score of the coach; and (vii) configuring the UI that is associated to the coaching application to selectively display a subset of the plurality of coaches based on the calculated coach impact score of each coach in the plurality of coaches. The subset of coaches may include a preconfigured number of coaches having the highest calculated coach impact score, and the calculated coach impact score of each coach may indicate an effectiveness-level of the coach to the new coaching session.

Furthermore, in accordance with some embodiments of the present disclosure, the set of coaching rating and the coaching comment have been provided by the agent when the coaching session has been acknowledged by the agent.

Furthermore, in accordance with some embodiments of the present disclosure, the bias that may be removed from the collected coaching feedback data may include at least one of: (i) specificity bias that includes comments which are not specific to the coaching session; (ii) differential bias that includes comment and related set of ratings that are not consistent; and (iii) consistency bias that includes same value for all ratings in the set of ratings.

Furthermore, in accordance with some embodiments of the present disclosure, the computerized-method may further include creating the new coaching session for the agent with a coach having highest coach impact score by operating a workflow service.

Furthermore, in accordance with some embodiments of the present disclosure, the computerized-method may further include: (i) creating a textual-summary of strengths and weaknesses of each coach in the plurality of coaches and a textual-summary of preferences of the agent by operating a Generative Artificial Intelligence (AI) on the filtered coaching feedback data; (ii) normalizing to numerical values with Euclidean norm of the created textual-summary of strengths and weaknesses of each coach in the plurality of coaches to represent coach-vector and the created textual-summary of preferences of the agent to represent agent-vector; (iii) pairing the agent-vector with each coach-vector of the coach; (iv) calculating a cosine similarity score for each pair of agent-vector and coach-vector; (v) calculating a correlational score for each coach in the plurality of coaches based on the respective calculated coach impact score and the respective calculated cosine similarity score. The calculated correlational score of each coach indicates a level to which the calculated coach impact score and agent behavioral preferences are aligned; and (vi) configuring the UI that is associated to the coaching application to selectively display a subset of the plurality of coaches based on the correlational score. The subset of coaches may include a preconfigured number of coaches having the highest calculated correlational score.

Furthermore, in accordance with some embodiments of the present disclosure, the computerized-method may further include creating the new coaching session for the agent with a coach having highest correlational score by operating a workflow service.

Furthermore, in accordance with some embodiments of the present disclosure, the computerized-method may further include selecting a preconfigured number of coaches from the plurality of coaches having lowest coach impact score and creating a coach-the-coach training session for the selected preconfigured number of coaches to improve their coach impact score for the received focus area and related behaviors.

Furthermore, in accordance with some embodiments of the present disclosure, the coach evaluation module may include for each coach in the plurality of coaches: (i) creating an average-normalized comment score and an average-normalized rating; (ii) calculating an effective-feedback score, according to formula I:

effective-feedback score=(preconfigured-weight-comment*average-normalized-comment score)+(preconfigured-weight-rating*average-normalized-rating) (I)

whereby:
the preconfigured-weight comment is a preconfigured weight that has been assigned to the average-normalized-comment score, the average-normalized-comment score is the created average-normalized comment score, the preconfigured-weight-rating is a preconfigured weight that has been assigned to the average-normalized-rating, the average-normalized-rating is the created average-normalized rating, (iii) retrieving a coaching effectiveness score for each coach for the selected focus area and related behavior during the preconfigured period from a database; (iv) determining a first-number of coaching sessions in the plurality of coaching sessions; (v) determining a second-number of coaching sessions in the plurality of coaching sessions that were conducted by a coach that has conducted the coaching session, and (vi) calculating a dynamic weightage for the effective-feedback score by dividing the second-number of coaching sessions by the first-number of coaching sessions.

Furthermore, in accordance with some embodiments of the present disclosure, the creating of the average-normalized comment score for each coach may include: (i) for each coaching comment in the collected feedback data that is related to a coaching session that is related to the coach: a. calculating a compound score of a sentiment of the coaching comment by operating a sentiment-intensity analyzer module on the coaching comment; b. when the calculated compound score has a negative value, then converting the calculated compound score to positive scale by averaging a sum of the negative value and ‘1’; and c. normalizing the compound score to a preconfigured rating-range to yield a normalized comment score and storing it in a comments-datastore, and (ii) calculating an average of all the normalized comment scores in the comments-datastore which are related to the coach to yield the average-normalized comment score.

Furthermore, in accordance with some embodiments of the present disclosure, the creating of the average-normalized rating may include: (i) for each set of coaching ratings in the collected feedback data that is related to a coaching session that is related to the coach calculating an average of ratings in the set of coaching ratings to yield a rating-score and storing it in a rating-datastore; (ii) calculating an average of all rating scores in the rating-datastore which are related to the coach to yield an average-ratings score; and (iii) converting the calculated average-ratings score to a preconfigured scale to yield the average-normalized rating.

Furthermore, in accordance with some embodiments of the present disclosure, the coaching impact score module may include calculating the coach impact score for each coach in the plurality of coaches, according to formula II:

coach impact score=(dynamic weightage*effective-feedback score)+((100−dynamic weightage)*coaching effectiveness score) (II)

whereby:
the dynamic weightage is the calculated dynamic weightage for the effective-feedback score, the effective-feedback score is the effective feedback score yielded by the coach evaluation module, and the coaching effectiveness score is a score that is retrieved from the database by the coach evaluation module for each coach for the selected focus area and related behavior during the preconfigured period.

There is further provided, in accordance with some embodiments of the present invention, a computerized-system for enhancing effectiveness of a coaching session of an agent by creating the coaching session based on a calculated coach impact score of coaches, in a contact center.

Furthermore, in accordance with some embodiments of the present disclosure, the computerized-system includes one or more processors; and a coaching web application. The one or more processors may be configured to: (i) receive coaching feedback data via the coaching web application from the agent after each coaching session that the agent has participated in. The coaching feedback data is about the coaching session and a related coach; (ii) receive a request from a user, via a User Interface (UI) that is associated to the coaching web application, to create a new coaching session to the agent for a selected focus area and related behaviors; (iii) collect the coaching feedback data that has been received from the agent for a plurality of coaching sessions that have been conducted during a preconfigured period. The collected feedback data comprising for each coaching session at least one of: (a) set of coaching ratings; and (b) coaching comment; (iv) filter bias from the coaching feedback data by removing bias therefrom to yield filtered coaching feedback data; (v) operate a coach evaluation module based on the filtered coaching feedback data, to yield an effective-feedback score, an associated dynamic weightage and a coaching effectiveness score, for each coaching session in the plurality of coaching sessions; (vi) calculate a coach impact score for each coach in the plurality of coaches by operating a coaching impact score module on the yielded effective-feedback score and the associated dynamic weightage and the coaching effectiveness score of the coach; and (vii) configure the UI that is associated to the coaching application to selectively display a subset of the plurality of coaches based on the calculated coach impact score of each coach in the plurality of coaches. The subset of coaches includes a preconfigured number of coaches having the highest calculated coach impact score, and the calculated coach impact score of each coach indicates effectiveness-level of the coach to the new coaching session.

Furthermore, in accordance with some embodiments of the present disclosure, the set of coaching rating and the coaching comment have been provided by the agent when the coaching session has been acknowledged by the agent.

Furthermore, in accordance with some embodiments of the present disclosure, the bias that is removed from the collected coaching feedback data comprising at least one of: (i) specificity bias that includes comments which are not specific; (ii) differential bias that includes comment and related set of ratings that are not consistent; and (iii) consistency bias that includes same value for all ratings in the set of ratings.

Furthermore, in accordance with some embodiments of the present disclosure, the one or more processors are further configured to create the new coaching session for the agent with a coach having highest coach impact score by operating a workflow service.

Furthermore, in accordance with some embodiments of the present disclosure, the one or more processors are configured to select a preconfigured number of coaches from the plurality of coaches having lowest coach impact score and to create a coach-the-coach training session for the selected preconfigured number of coaches to improve their coach impact score for the received focus area and related behaviors.

Furthermore, in accordance with some embodiments of the present disclosure, the coach evaluation module may include for each coach in the plurality of coaches: (i) creating an average-normalized comment score and an average-normalized rating; (ii) calculating an effective-feedback score according to formula I:

effective-feedback score=(preconfigured-weight-comment*average-normalized-comment score)+(preconfigured-weight-rating*average-normalized-rating) (I)

whereby:
the preconfigured-weight comment is a preconfigured weight that has been assigned to the average-normalized-comment score,
the average-normalized normalized-comment score is the created average-normalized normalized comment score,
the preconfigured-weight-rating is a preconfigured weight that has been assigned to the average-normalized-rating, and
the average-normalized normalized-rating is the created average-normalized normalized rating, (iii) retrieving a coaching effectiveness score for each coach for the selected focus area and related behavior during the preconfigured period from a database; (iv) determining a first-number of coaching sessions in the plurality of coaching sessions; (v) determining a second-number of coaching sessions in the plurality of coaching sessions that were conducted by a coach that has conducted the coaching session, and (vi) calculating a dynamic weightage for the effective-feedback score by dividing the second-number of coaching sessions by the first-number of coaching sessions.

Furthermore, in accordance with some embodiments of the present disclosure, the creating of the average-normalized comment score for each coach may include: (i) for each coaching comment in the collected feedback data that is related to a coaching session that is related to the coach: a. calculating a compound score of a sentiment of the coaching comment by operating a sentiment-intensity analyzer module on the coaching comment; b. when the calculated compound score has a negative value, then converting the calculated compound score to positive scale by averaging a sum of the negative value and ‘1’; and c. normalizing the compound score to a preconfigured rating-range to yield a normalized comment score and storing it in a comments-datastore, and (ii) calculating an average of all the normalized comment scores in the comments-datastore which are related to the coach to yield the average-normalized comment score.

Furthermore, in accordance with some embodiments of the present disclosure, the creating of the average-normalized rating may include: (i) for each set of coaching ratings in the collected feedback data that is related to a coaching session that is related to the coach calculating an average of ratings in the set of coaching ratings to yield a rating-score and storing it in a rating-datastore; (ii) calculating an average of all rating scores in the rating-datastore which are related to the coach to yield an average-ratings score; and (iii) converting the calculated average-ratings score to a preconfigured scale to yield the average-normalized rating.

Furthermore, in accordance with some embodiments of the present disclosure, the coaching impact score module comprising calculating the coach impact score for each coach in the plurality of coaches, according to formula II:

coach impact score=(dynamic weightage*effective-feedback score)+((100−dynamic weightage)*coaching effectiveness score), (II)

whereby:
the dynamic weightage is the calculated dynamic weightage for the effective-feedback score, the effective-feedback score is the effective feedback score yielded by the coach evaluation module, and the coaching effectiveness score is a score that is retrieved from the database by the coach evaluation module for each coach for the selected focus area and related behavior during the preconfigured period.

### BRIEF DESCRIPTION OF THE DRAWINGS

In order for the present invention, to be better understood and for its practical applications to be appreciated, the following Figures are provided and referenced hereafter. It should be noted that the Figures are given as examples only and in no way limit the scope of the invention. Like components are denoted by like reference numerals.

FIG. 1A schematically illustrates a high-level diagram of a computerized-system for creating a coaching session of an agent, in a contact center;

FIG. 1B schematically illustrates a high-level diagram of a computerized-system for enhancing effectiveness of a coaching session of an agent by creating the coaching session based on a calculated coach impact score of coaches, in a contact center, in accordance with some embodiments of the present invention;

FIGS. 2A-2C schematically illustrates a high-level diagram of a computerized-method for enhancing effectiveness of a coaching session of an agent by creating the coaching session based on a calculated coach impact score of coaches, in a contact center, in accordance with some embodiments of the present invention;

FIG. 3 schematically illustrates a high-level diagram of a system for enhancing effectiveness of a coaching session of an agent by creating the coaching session based on a calculated coach impact score of coaches, in a contact center, in accordance with some embodiments of the present invention;

FIG. 4A-4C schematically illustrates a high-level diagram of enhancing effectiveness of a coaching session of an agent by creating the coaching session based on a calculated coach impact score of coaches, in a contact center, in accordance with some embodiments of the present invention;

FIG. 5 is an example of a classification report, in accordance with some embodiments of the present invention;

FIG. 6 is an example of a textual summary of strengths and weaknesses of a coach, in accordance with some embodiments of the present invention;

FIG. 7 is an example of a textual summary of agent's preference to get coached, in accordance with some embodiments of the present invention;

FIG. 8 is an example of two vectors of agent's preferences and coach's strengths and weaknesses, in accordance with some embodiments of the present invention;

FIG. 9 is an example of cosine similarity score of an agent with each coach in a plurality of coaches, in accordance with some embodiments of the present invention;

FIG. 10 is an example of impact score, cosine similarity score and correlational score of an agent with each coach in a plurality of coaches, in accordance with some embodiments of the present invention;

FIG. 11 is an example of feedback and ratings associated with the coach given by agents for particular coaching sessions, in accordance with some embodiments of the present invention;

FIG. 12 is an example of a list of coaches and related calculated coach impact score and effectiveness score for a selected focus area and related behavior, in accordance with some embodiments of the present invention;

FIG. 13 is an example of the feedback and effectiveness score, in accordance with some embodiments of the present invention;

FIG. 14 is an example of coaching impact score, in accordance with some embodiments of the present invention;

FIG. 15 is an example of agent preferences, in accordance with some embodiments of the present invention;

FIG. 16 is an example of a User Interface (UI) to create a new coaching session based on a calculated coach impact score, in accordance with some embodiments of the present invention; and

FIG. 17 is an example of a coach dashboard presenting coach impact score and strengths and weaknesses, in accordance with some embodiments of the present invention.

### DETAILED DESCRIPTION

In the following detailed description, numerous specific details are set forth in order to provide a thorough understanding of the disclosure. However, it will be understood by those of ordinary skill in the art that the disclosure may be practiced without these specific details. In other instances, well-known methods, procedures, components, modules, units and/or circuits have not been described in detail so as not to obscure the disclosure.

Although embodiments of the disclosure are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium (e.g., a memory) that may store instructions to perform operations and/or processes.

Although embodiments of the disclosure are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. Unless explicitly stated, the method embodiments described herein are not constrained to a particular order or sequence. Additionally, some of the described method embodiments or elements thereof can occur or be performed simultaneously, at the same point in time, or concurrently. Unless otherwise indicated, use of the conjunction “or” as used herein is to be understood as inclusive (any or all of the stated options).

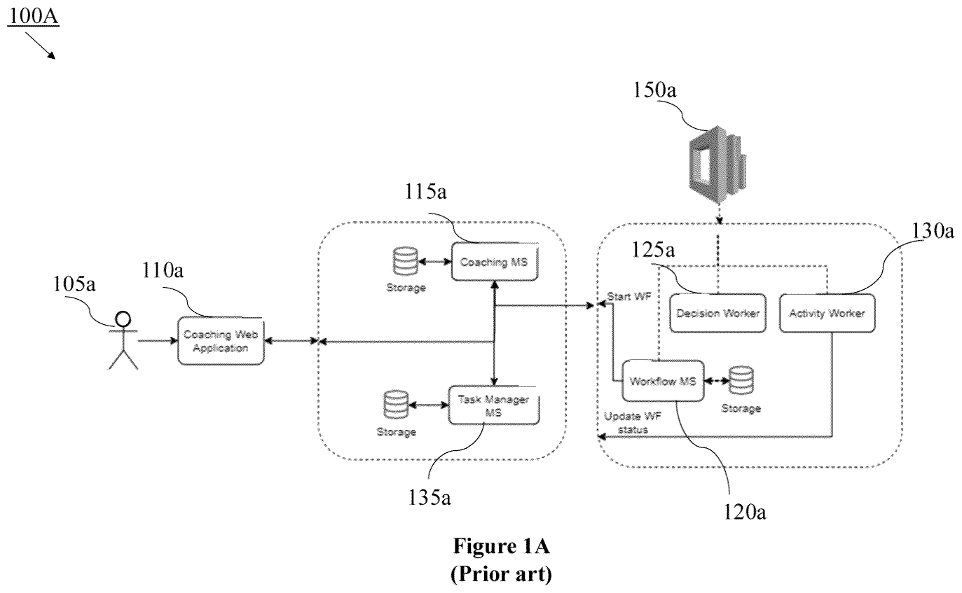

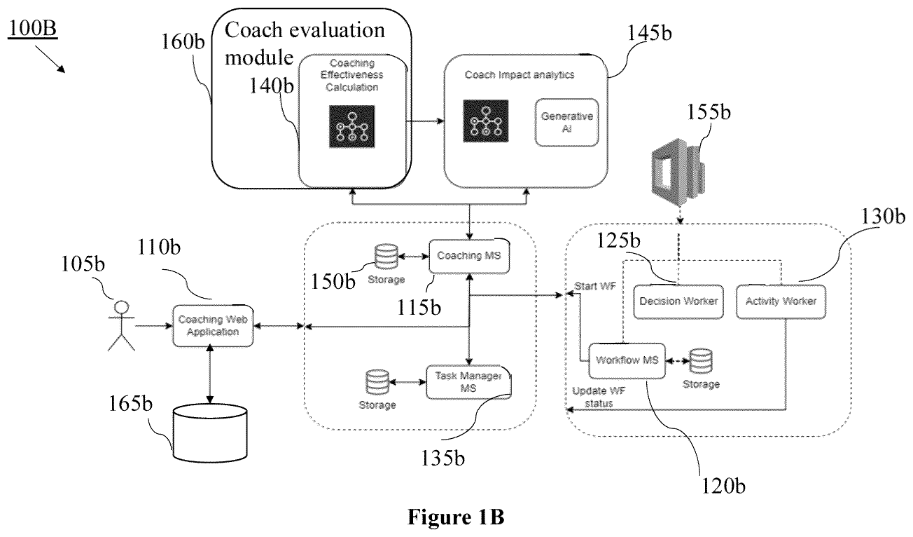

FIG. 1A schematically illustrates a high-level diagram of a computerized-system 100A for creating a coaching session of an agent, in a contact center.

To boost agent performance, contact centers conduct coaching sessions for their employees, aiming to align them with feedback, best practices, assessment insights, and knowledge-sharing topics.

In current technical solutions, the agent performance and insights are translated into a coaching need identification. Based upon the identified coaching need a user 105a is creating a coaching session via a coaching web application 110a and then executing it in the time that it has been scheduled to. After the coaching session the agent acknowledges and perform tasks.

The coach that is responsible for initiating and conducting coaching sessions evaluates a range of factors, including the agent's performance, areas of strength and weakness, productivity, and proficiency metrics, to identify agents who would benefit from a coaching session. Once the identification is done, the coach will hold a session with the agent to be coached, during which the findings and insights will be shared with the agent.

The Agents undergoing coaching employ the knowledge acquired during the coaching session to enhance their overall performance in the contact center. They utilize the topics covered in the coaching session, insights, and any assigned tasks to reinforce their learning and improvement.

A coaching session is a structured and purposeful session by a coach for a contact center agent, aimed at improving the agent's performance and skills. It's typically focused on improving customer interactions, problem-solving, adherence to company policies, and achieving performance targets.

A coaching session involves two important personas which are the coach and the contact center agents along with the content used for the coaching session. The coach is usually a more experienced or knowledgeable individual within the contact center or organization who is responsible for guiding and mentoring the agent. Coaches can be other agents, supervisors, agents-team leaders, or specialized trainers.

The agents being coached are active participants in the coaching session. They are expected to engage, ask questions, and receive feedback constructively. The content used in the coaching session can be development resources, such as training materials, e-learning modules, or one-on-one training to address specific skill gaps.

For effective coaching, the coach relies on categorizations, artifacts, and tools, which are collectively known as coaching content. The coaching contents include Focus Areas (FA)s. By considering performance, insights and additional metrics, the coach discerns the agent's areas in need of improvement. These areas of enhancement are then generalized at the organizational level and commonly referred to as ‘Focus Areas’ (FA)s. For example, productivity may be a focus area, which denotes that the agent needs to focus on improving productivity.

The FAs are linked to related behaviors which are behavioral characteristics which offer a more detailed level of improvement for the agent. For example, to reduce idle-time which denotes that in order to improve productivity the agents need to improve their behavior to reduce idle-time during a call or interaction.

Interactions are essentially excerpts from real conversations between contact center agents and customers. The coach frequently utilizes interactions to highlight both the areas that need improvement and the areas where the agent excelled.

Commonly, the organization has a set of guidelines that must be adhered to when engaging with customers. These guidelines are accessible in various formats, including documents, videos, audio files, and links. The compilation of these resources is commonly referred to as a knowledge base.

At present, coaches are responsible for developing coaching sessions for agents. These coaching sessions are tailored to each agent's performance indicators, strengths and weaknesses, productivity, and competence levels. To initiate a coaching session, the coach accesses the coaching software, such as web coaching application 110a and organizes coaching sessions for single or multiple agents.

During the procedure of creating the coaching session, the coach identifies and selects a suitable focus area and related behavior, as well as selecting previous interactions involving the agents. Additionally, the coach can attach informational materials to the session for the agents to reference.

The process of selecting focus areas, behaviors, interactions, and attachments is carried out manually by the coach 105a via the web coaching application 110a, without any support to evaluate their pertinence. Consequently, the process is subjective and depends on the coach's abilities, insight, and discernment. The related material from the knowledge base is linked to the coaching session by the selected focus area and related behavior.

The web application 110a also facilitates the agent to request a coaching session when the agent requires coaching in a specific area. When a coach creates a coaching session, the coach has an option to delegate the coaching session to some other coaches. The coaching session has below specified information from the coach, e.g., focus area, related behavior, and participants to facilitate the creation of a coaching session.

A coaching service, such as coaching Microservice (MS) 115a is associated to the coaching web application 110a and provides the generating of coaching sessions, as well as interacts with additional services to guarantee the comprehensive completion of the coaching session creation. This coaching service receives data from the coaching web application 110a and establishes a coaching session within the system 100A.

A workflow service, such as workflow Microservice (MS) 120a, facilitates the creation of coaching sessions, by interacting with additional services to guarantee the seamless completion of session creation. The service receives data from the coaching web application 110a and generates a coaching session within the system 100A. The coaching session may be created for one or more participants.

A workflow service accepts a workflow configuration for creating workflows for a coaching session and workflow details to create the workflow in the workflow MS 120a.

A decision worker service 125a is executing the steps of the created workflow to manage the entire journey of a coaching session through different states. An activity service, such as activity worker service 130a, comprises of business logic present at each step of the coaching session workflow. The journey of coaching sessions is managed through different states, by a service 150a which primarily comprises of the decision worker service 125a and the activity worker service 130a, for example the service 150a may be provided by Simple Workflow Service (SWF) of on-demand cloud computing services provider, such as Amazon® Web Services (AWS).

A task manager MS 135a is responsible for maintaining task-related information of coaching sessions. The current coaching flow in contact centers presents certain limitations that may affect the effectiveness of the coaching sessions. These limitations include lack of assessment of coach's expertise in a specific focus area, as when assigning a coach to a coaching session, there is no evaluation of how well-suited the coach is for the given focus area and related behavior. This lack of assessment may result in a mismatch between the coach's skills and the agent's needs, potentially reducing the session's effectiveness.

The limitations further include ignoring the coach's strengths and weaknesses, and the agent's preferences, as the current coaching process does not consider the coach's strengths and weaknesses or the agent's preferences when conducting the coaching sessions. This oversight may lead to less personalized and less effective coaching, as the coaching sessions may not be tailored to both the coach's expertise and the agent's unique learning preferences.

Current technical solutions fail to identify and leverage the coach's expertise with which employees can enhance their abilities, which ultimately contributes to the overall success of the business. They fail to identify and evaluate a coach's impact on the coaching session which is essential to ensure its success and they also fail to provide an active assessment of the coach's abilities, experience, and track record before engaging them in coaching activities.

FIG. 1B schematically illustrates a high-level diagram of a computerized-system 100B for enhancing effectiveness of a coaching session of an agent by creating the coaching session based on a calculated coach impact score of coaches, in a contact center, in accordance with some embodiments of the present invention.

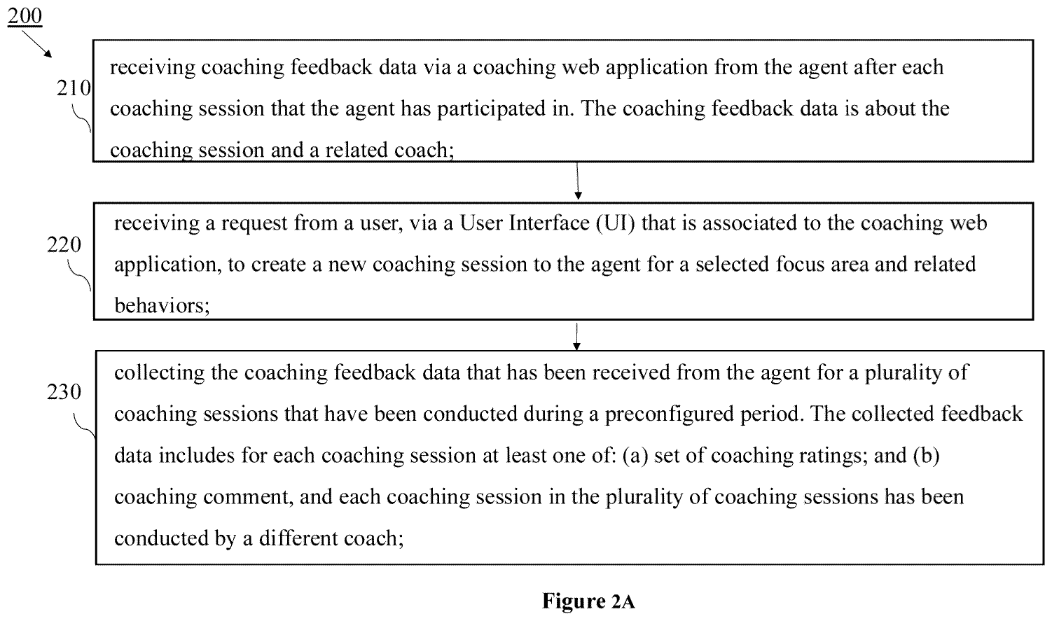

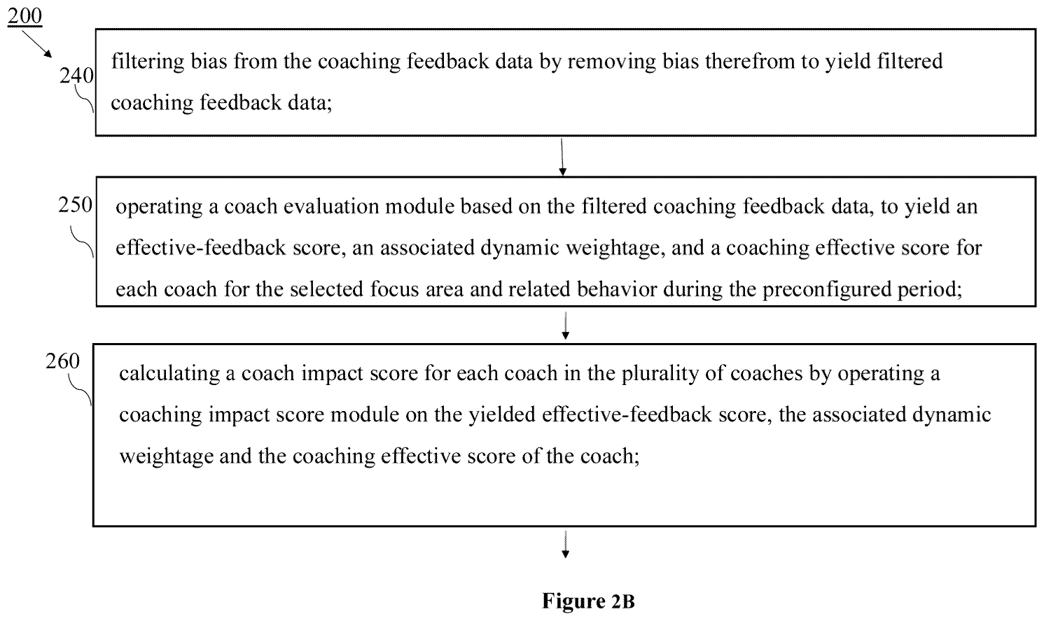

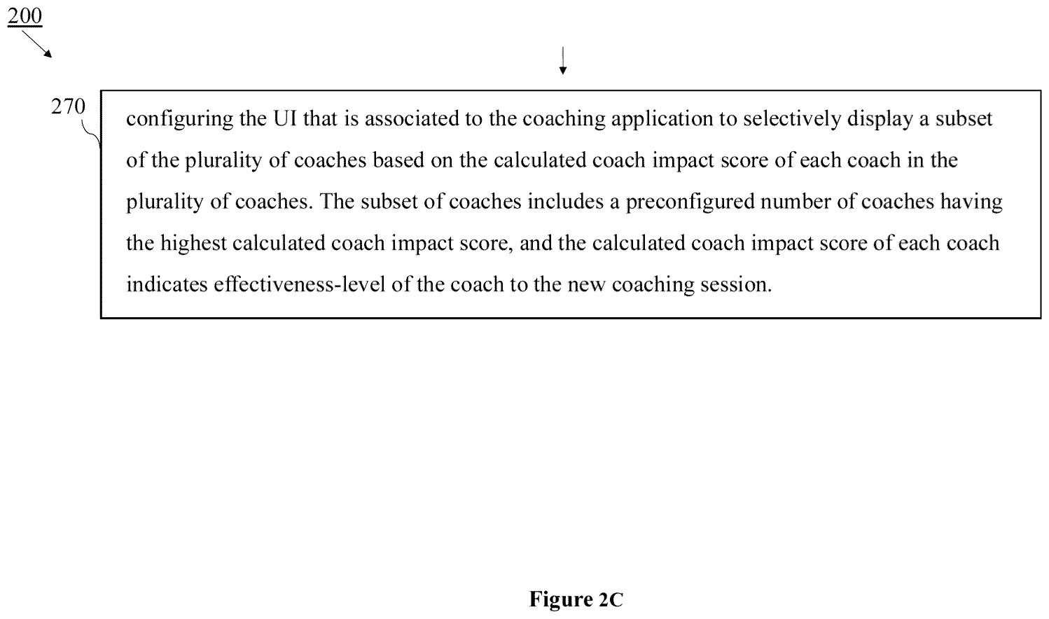

According to some embodiments of the present disclosure, a system, such as system 100B may implement a computerized-method, such as computerized-method 200 in FIGS. 2A-2C for enhancing effectiveness of a coaching session of an agent by creating the coaching session based on a calculated coach impact score of coaches, in a contact center.

According to some embodiments of the present disclosure, the implemented computerized-method may evaluate coach's impact on the coaching effectiveness for a selected focus area and related behavior and suggest best coaches with highest impact score via a supervised machine learning algorithm, which is used for classification tasks, like text classification, such as Naïve Bayes, a Natural Language Processing (NLP) Model implemented in a Transformer library, such as DistilBERT-base-uncased and mathematical models.

According to some embodiments of the present disclosure, system 100B may also identify the most aligned impacting coach to identified agent's preferences by using normalization with a statistical measure that evaluates how relevant a word is to a document in a collection of documents, such as Term Frequency-Inverse Document Frequency (TF-IDF) representation, Euclidean norm and correlational building with cosine similarity and Generative (Gen) Artificial Intelligence (AI). The Gen AI may be implemented with Large Language Model (LLM), for example, via Azure® OpenAI Application Programming Interfaces (API) s.

According to some embodiments of the present disclosure, system 100B may receive coaching feedback data via a coaching web application 110b from the agent after each coaching session that the agent has participated in. The coaching feedback data is about the coaching session and a related coach. The coaching session has been created by a user 105b, such as a coach.

According to some embodiments of the present disclosure, the coaching web application 110b is designed for overseeing coaching sessions. This coaching web application 110b also facilitates the agent to request a coaching session if the agent needs coaching in a specific area. Additionally, when a coach creates a coaching session, the coach has an option to delegate the coaching session to other coaches.

According to some embodiments of the present disclosure, the coaching session includes information to facilitate the coaching session, such as focus area and related behavior, interactions, coach and one or more participants, which has been received from the user 105b that created the coaching session.

According to some embodiments of the present disclosure, the coaching service, such as coaching MS 115b, is responsible for generating coaching sessions. The service interacts with additional services to guarantee the comprehensive completion of coaching session creation. This service receives data from the coaching web application 110b and establishes a coaching session within the system. The service also provides the coaching session related data for coaching effectiveness calculations for the coach evaluation module 160b and coach impact analytics module 145b.

According to some embodiments of the present disclosure, the results of the coach evaluation module, such as coach evaluation module 160b, that may retrieve a coaching effectiveness score, which has been calculated by a module, such as coaching effectiveness calculation module 140b and the results of a coaching impact score module, such as coach impact analytics module 145b may be stored in a storage 150b that is associated with the coaching MS 115b.

According to some embodiments of the present disclosure, a workflow service, such as workflow MS 120b, may facilitate the creation of coaching sessions, interacting with additional services to guarantee the seamless completion of the coaching session creation. The service receives data from the coaching web application 110b and generates a coaching session within the system 100B. The coaching session may be created for one or more agents.

According to some embodiments of the present disclosure, the decision worker service 125b assists in executing the steps of the coaching session workflow to manage the entire journey of a coaching session through different states and the activity worker service 130b comprises of business logic present at each step of the coaching session workflow.

According to some embodiments of the present disclosure, a task manager service, such as task manager MS 135b, is responsible for maintaining task-related information of coaching sessions. The journey of coaching sessions is managed through different states, by a service 155b which primarily comprises of the decision worker service 125b and the activity worker service 130b. For example, the service 155b may be provided by Simple Workflow Service (SWF) of on-demand cloud computing services provider, such as Amazon® Web Services (AWS).

According to some embodiments of the present disclosure, the coach evaluation module 160b, may retrieve a coaching effectiveness score for each coach that has conducted a coaching session for the agent for the selected focus area and related behavior during a preconfigured period. The coaching effectiveness score has been calculated by a module, such as coaching effectiveness calculation job 140b, which may run daily for each coaching session. This coaching effectiveness calculation job 140b consumes data from coaching MS 115b for each coaching session related focus areas and behaviors and calculates a coaching effectiveness score for each coaching session based on metric performance improvement. The coaching effectiveness calculation job 140b may be implemented for example, as described in detail in U.S. Pat. No. 11,403,579 B2. Based on the calculated coaching effectiveness score of each coaching session, a coaching effectiveness score for each coach may be calculated for the selected focus area and related behavior during the preconfigured period. For example, the coaching effectiveness score for each coach may be calculated as an average of all the coaching effectiveness scores which are related to the coaching sessions in the plurality of coaching sessions of the coach during that preconfigured period of time.

According to some embodiments of the present disclosure, a module, such as coaching impact score module and such as coach impact score analytics module 145b may consume data from the coaching service, such as coaching MS 115b for past coaching sessions related details for a preconfigured period t, e.g., 90 days. The coaching sessions related details may include for each coaching session, coach name, focus area, behavior, participants, agent's set of ratings for coaching session, and the agent's comment for the coaching session.

According to some embodiments of the present disclosure, system 100B may receive coaching feedback data via the coaching web application 110b from the agent after each coaching session that the agent has participated in. The coaching feedback data is about the coaching session and the related coach. The received coaching feedback data may be stored in a data storage, such as database 165b.

According to some embodiments of the present disclosure, system 100B may receive a request from a user 105b, via a User Interface (UI) that is associated to the coaching web application 110b, to create a new coaching session to the agent for a selected focus area and related behaviors.

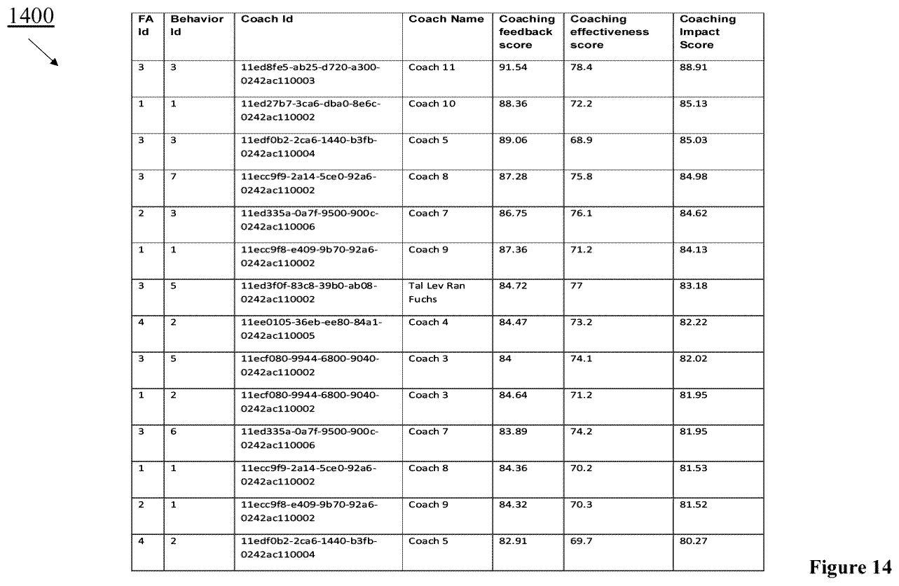

According to some embodiments of the present disclosure, the coaching impact score module, such as coach impact analytics 145b, may calculate the coach impact score for each coach in the plurality of coaches in the plurality of coaching sessions that have been conducted for the agent during the preconfigured period for the selected focus area and related behaviors. For example, as shown in FIG. 14.

According to some embodiments of the present disclosure, the coach impact score may be calculated based on an effective-feedback score, an associated dynamic weightage, and a coaching effectiveness score for each coach for the selected focus area and related behavior during the preconfigured period.

According to some embodiments of the present disclosure, the effective-feedback score, the associated dynamic weightage, and the coaching effectiveness score for each coach for the selected focus area and related behavior during the preconfigured period may be provided by operating a module, such as coach evaluation module 160b.

According to some embodiments of the present disclosure, the coach evaluation module 160b may operate on coaching feedback data that has been received from the agent for a plurality of coaching sessions for the selected focus area and related behavior, that have been conducted during a preconfigured period and has been filtered from biased data. The coaching feedback data that has been received from the agent for a plurality of coaching sessions that have been conducted during a preconfigured period, may be collected from database 165b. For example, storage services of cloud computing platform, such as Azure of Microsoft®.

According to some embodiments of the present disclosure, the biased data that is removed from the collected coaching feedback data may include at least one of: (i) specificity bias that includes comments which are not specific to the coaching session; (ii) differential bias that includes comment and related set of ratings that are not consistent; and (iii) consistency bias that includes same value for all ratings in the set of ratings.

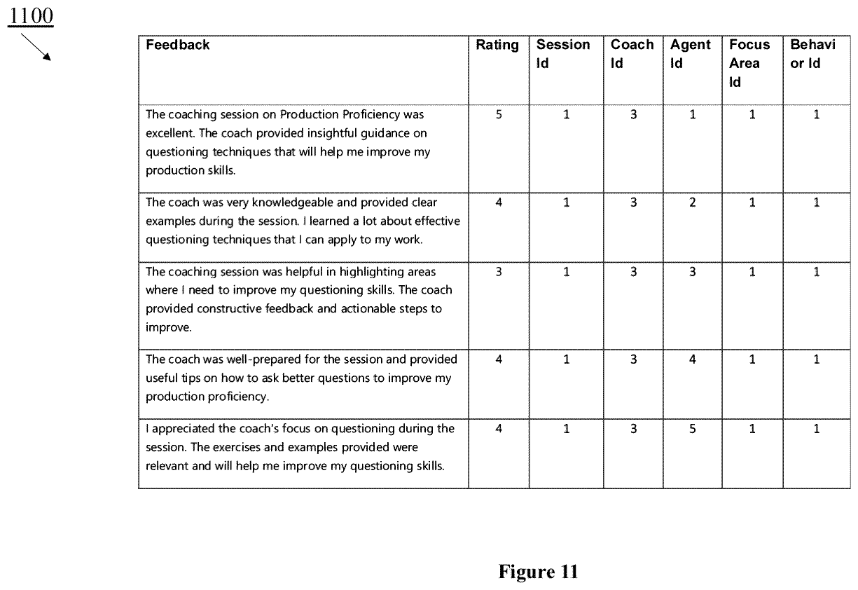

According to some embodiments of the present disclosure, the collected feedback data may include for each coaching session at least one of: (a) set of coaching ratings; and (b) coaching comment. Each coaching session in the plurality of coaching sessions has been conducted by a different coach. The set of coaching rating and the coaching comment have been provided by the agent when the coaching session has been acknowledged by the agent, for example, as shown in FIG. 11.

According to some embodiments of the present disclosure, the collected coaching feedback data may be filtered from bias by removing biased data from the collected coaching feedback data.

According to some embodiments of the present disclosure, the coach evaluation module 160b may include for each coach in the plurality of coaches: (i) creating an average-normalized comment score and an average-normalized rating; (ii) calculating an effective-feedback score according to formula I:

effective-feedback score=(preconfigured-weight-comment*average-normalized-comment score)+(preconfigured-weight-rating*average-normalized-rating) (I)

whereby:
the preconfigured-weight comment is a preconfigured weight that has been assigned to the average-normalized-comment score,
the average-normalized-comment score is the created average-normalized comment score,
the preconfigured-weight-rating is a preconfigured weight that has been assigned to the average-normalized-rating, and
the average-normalized-rating is the created average-normalized rating.

According to some embodiments of the present disclosure, the coach evaluation module 160b may further include: (iii) retrieving a coaching effectiveness score for each coach for the selected focus area and related behavior during the preconfigured period, from a database; (iv) determining a first-number of coaching sessions in the plurality of coaching sessions; (v) determining a second-number of coaching sessions in the plurality of coaching sessions that were conducted by a coach that has conducted the coaching session, and (vi) calculating a dynamic weightage for the effective-feedback score by dividing the second-number of coaching sessions by the first-number of coaching sessions.

According to some embodiments of the present disclosure, the creating of the average-normalized comment score for each coach may include: (i) for each coaching comment in the collected feedback data that is related to a coaching session that is related to the coach: a. calculating a compound score of a sentiment of the coaching comment, which is a numeric score that is derived from the verbatim comment, by operating a sentiment-intensity analyzer module on the coaching comment; b. when the calculated compound score has a negative value, then converting the calculated compound score to positive scale by averaging a sum of the negative value and ‘1’; and c. normalizing the compound score to a preconfigured rating-range to yield a normalized comment score and storing it in a comments-datastore, and (ii) calculating an average of all the normalized comment scores in the comments-datastore which are related to the coach to yield the average-normalized comment score.

According to some embodiments of the present disclosure, the sentiment-intensity analyzer module may be implemented by a lexicon and rule-based sentiment analysis tool that provides sentiments expressed in text, such as open-source Valence Aware Dictionary and sEntiment Reasoner (VADER) sentiment lib, which provides SentimentIntensityAnalyzer.

According to some embodiments of the present disclosure, the creating of the average-normalized rating may include (i) for each set of coaching ratings in the collected feedback data that is related to a coaching session that is related to the coach, calculating an average of ratings in the set of coaching ratings to yield a rating-score and storing it in a rating-datastore; (ii) calculating an average of all rating scores in the rating-datastore which are related to the coach to yield an average-ratings score; and (iii) converting the calculated average-ratings score to a preconfigured scale to yield the average-normalized rating.

According to some embodiments of the present disclosure, the coaching impact score module, such as coach impact analytics 145b may include calculating the coach impact score for each coach in the plurality of coaches, according to formula II:

coach impact score=(dynamic weightage*effective-feedback score)+((100−dynamic weightage)*coaching effectiveness score) (II)

whereby:
the dynamic weightage is the calculated dynamic weightage for the effective-feedback score,
the effective-feedback score is the effective feedback score yielded by the coach evaluation module, and the coaching effectiveness score is a score that is retrieved from the database by the coach evaluation module for each coach for the selected focus area and related behavior during the preconfigured period.

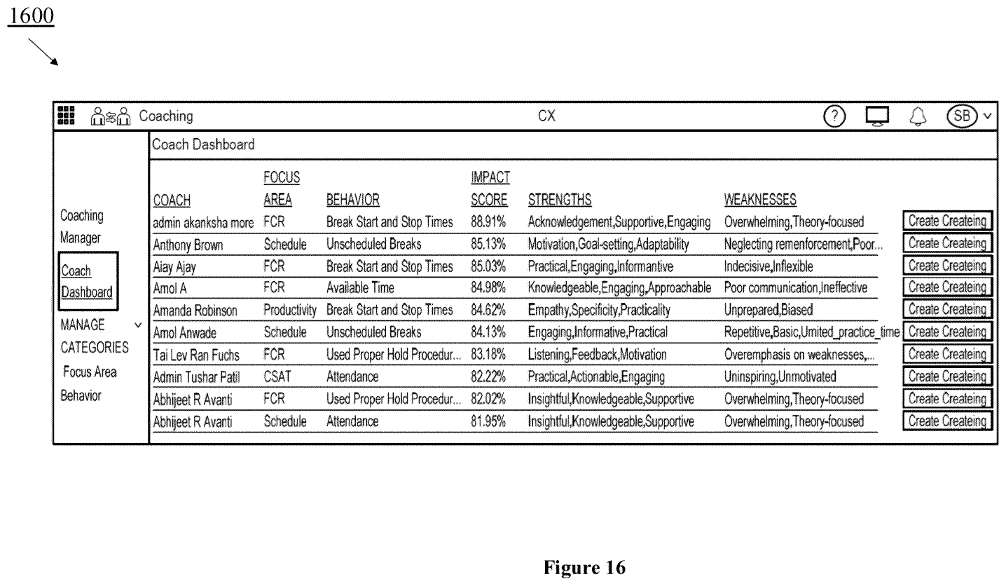

According to some embodiments of the present disclosure, a UI that is associated to the coaching application, such as coaching web application 110b, may be configured to selectively display a subset of the plurality of coaches based on the calculated coach impact score of each coach in the plurality of coaches. The subset of coaches may include a preconfigured number of coaches having the highest calculated coach impact score. For example, as shown in FIG. 16. The calculated coach impact score of each coach indicates an effectiveness-level of the coach to the new coaching session.

According to some embodiments of the present disclosure, the new coaching session for the agent may be created with a coach having highest coach impact score by operating a workflow service, such as workflow MS 120b.

According to some embodiments of the present disclosure, a new coach-to-coach training session may be created to a selected preconfigured number of coaches having lowest impact score to improve their coach impact score for the received focus area and related behaviors.

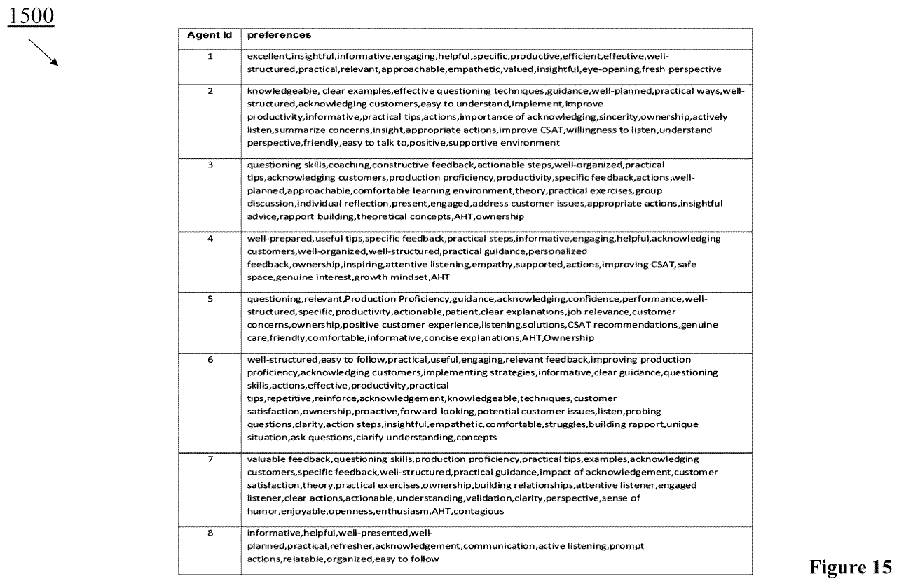

According to some embodiments of the present disclosure, a correlational score may be further calculated, for each coach in the plurality of coaches, based on the respective calculated coach impact score and a respective calculated cosine similarity score. The calculated correlational score of each coach indicates a level to which the calculated coach impact score and agent behavioral preferences, such as shown in FIG. 15, are aligned.

According to some embodiments of the present disclosure, the calculating of the correlational score may be operated by: (i) creating a textual-summary of strengths and weaknesses of each coach in the plurality of coaches and a textual-summary of preferences of the agent by operating a Generative Artificial Intelligence (AI) on the filtered coaching feedback data; (ii) normalizing to numerical values with Euclidian norm of the created textual-summary of strengths and weaknesses of each coach in the plurality of coaches to represent coach-vector and the created textual-summary of preferences of the agent to represent agent-vector; (iii) pairing the agent-vector with each coach-vector of the coach; (iv) calculating a cosine similarity score for each pair of agent-vector and coach-vector; and (v) calculating a correlational score for each coach in the plurality of coaches based on the respective calculated coach impact score and the respective calculated cosine similarity score. The coach having highest correlational score denotes that the coach is the most relevant coach for an agent based on agent's preferences and coach's strengths and weaknesses and coach's impact score. The Gen AI may be implemented with Large Language Model (LLM), for example, via Azure® OpenAI Application Programming Interfaces (API) s.

According to some embodiments of the present disclosure, the calculating of the correlational score may be performed by formula III:

correlational score=(weight_cosine_similarity*cosine similarity score)+(weight_coach_impact_score+coach impact score), (III)

whereby:
weight_cosine_similarity is a preconfigured weightage for cosine similarity score consideration, out of 100, for example, 30.
cosine_similarity_score is a score for agent's preferences and coach's strengths and weaknesses,
weight_coach_impact_score is a preconfigured weightage for coach impact score. For example, 100−the weight_cosine_similarity, for example, 70.

According to some embodiments of the present disclosure, the operating of the Generative AI with LLM on the filtered coaching feedback data to create the textual-summary of strengths and weaknesses of each coach in the plurality of coaches may include providing a prompt-text where the filtered coaching feedback data is embedded. For example, the provided prompt-text may be as follows: prompt-text=“Please analyze the following coaching feedbacks and derive the strengths and weaknesses. Give these attributes in one word. Consolidate all the strengths and weakness and give Only list of top 3 values of each category. If there are no values on any category print NA once. Also don't number the strengths and weaknesses. They should be pipe separated:\n\n{coaching feedback data}”.

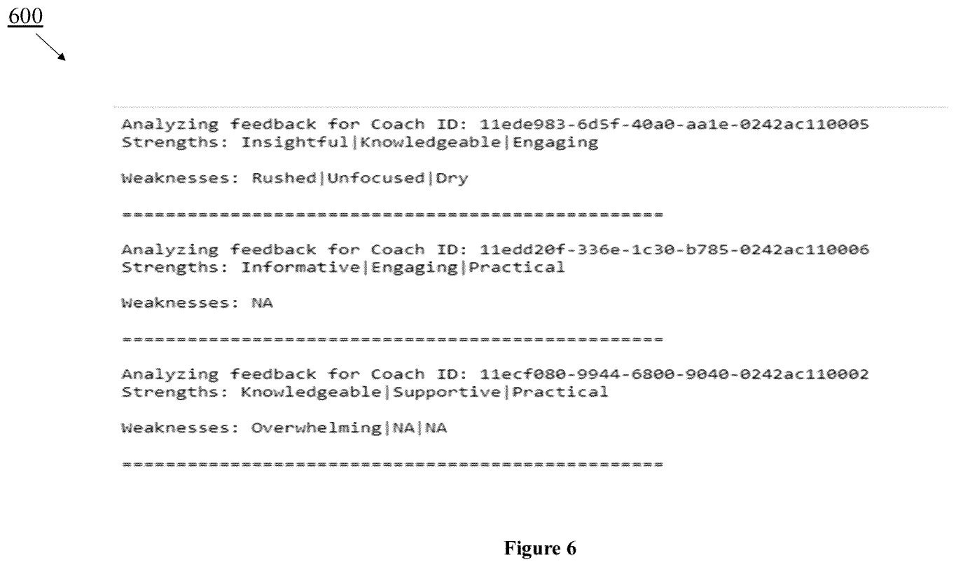

According to some embodiments of the present disclosure, the Generative AI may provide a text-summary of strengths and weaknesses of each coach, for example as shown in FIG. 6.

According to some embodiments of the present disclosure, the operating of the Generative AI with LLM on the filtered coaching feedback data to create the textual-summary of preferences of the agent, may include providing a prompt-text where the filtered coaching feedback data is embedded. For example, the provided prompt-text may be as follows: prompt-text=“Analyze the following feedback comments and determine the agent's preference to get coached. Give these preference in singes words only rather than statement and it should be pipe separated: {coaching feedback data}”

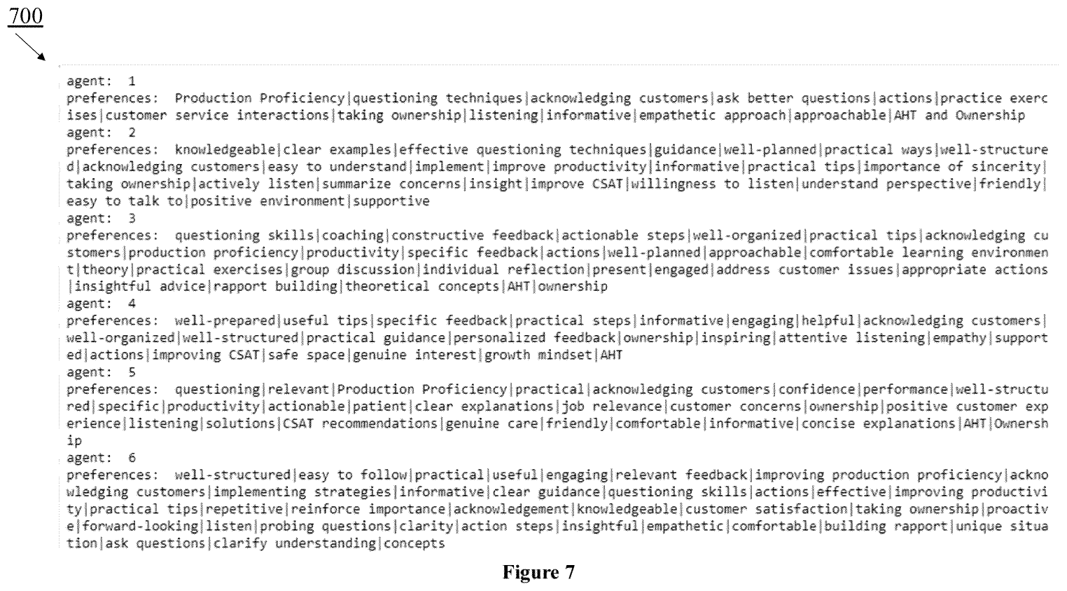

According to some embodiments of the present disclosure, the Generative AI may provide a text-summary of preferences of the agent, for example as shown in FIG. 7. The coaching session may be created for one or more agents and the preferences of each agent shown in FIG. 7 are related to each agent that is participating in the new coaching session.

According to some embodiments of the present disclosure, the calculated correlational score of each coach indicates a level to which the calculated coach impact score and agent behavioral preferences are aligned. A UI that is associated to the coaching application, such as coaching web application 110b, may be configured to selectively display a subset of the plurality of coaches based on the correlational score. The subset of coaches may include a preconfigured number of coaches having the highest calculated correlational score.

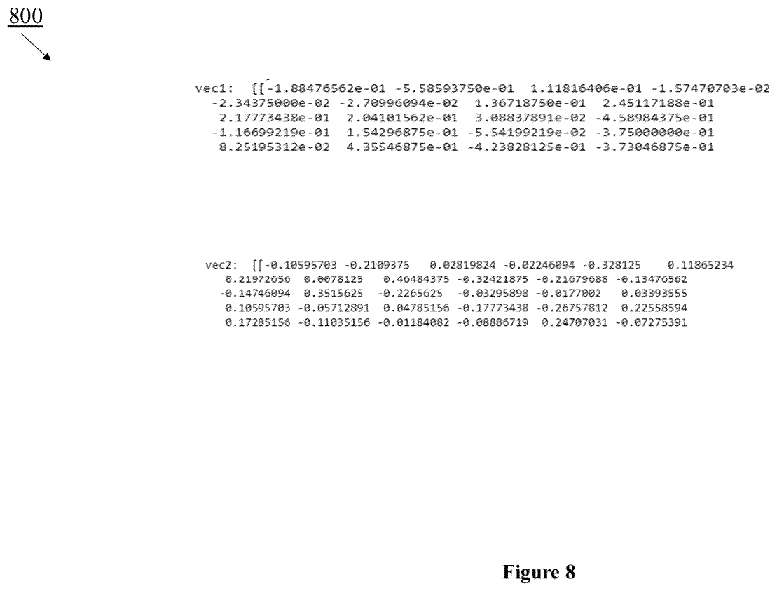

According to some embodiments of the present disclosure, the normalizing of the numerical values, e.g., the average-normalized comment score and an average-normalized rating with Euclidian norm of the created textual-summary of strengths and weaknesses of each coach in the plurality of coaches to represent coach-vector and the created textual-summary of preferences of the agent to represent agent-vector, for example as shown in FIG. 8.

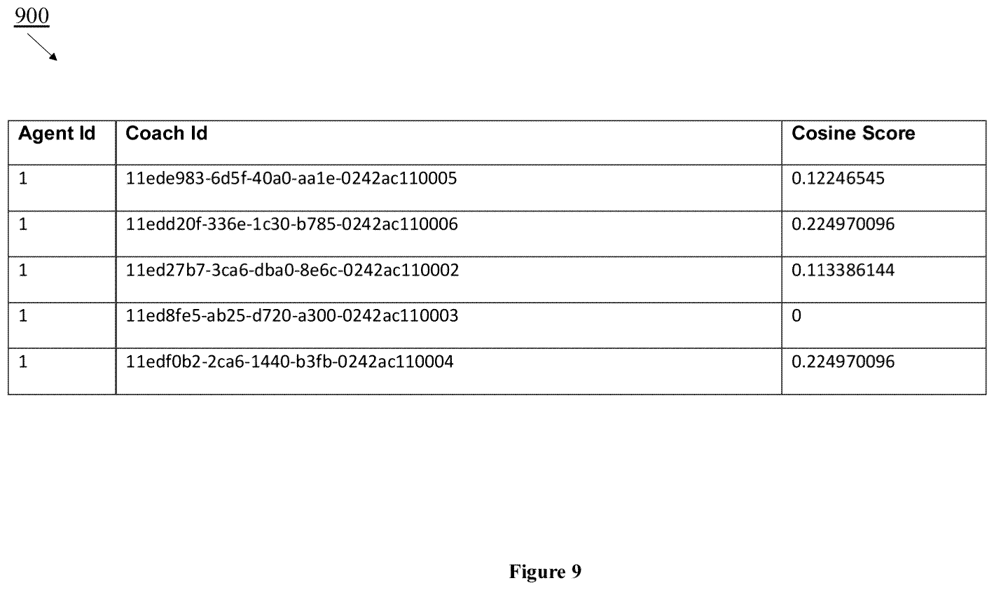

According to some embodiments of the present disclosure, the cosine similarity score for each pair of agent-vector and coach-vector may be calculated by cosine similarity library from sklearn.metrics module. For example, for agentid ‘1’ the similarity score for each coach in the plurality of coaches may be as shown in table 900 in FIG. 9. The similarity score value of the two vectors, coach-vector and agent-vector, in FIG. 8 is 0.21525891 and it designates the extent to which agent's preference and coach's strengths and weaknesses are similar. The higher the score on scale of ‘0’ to ‘1’ means higher similarity hence alignment.

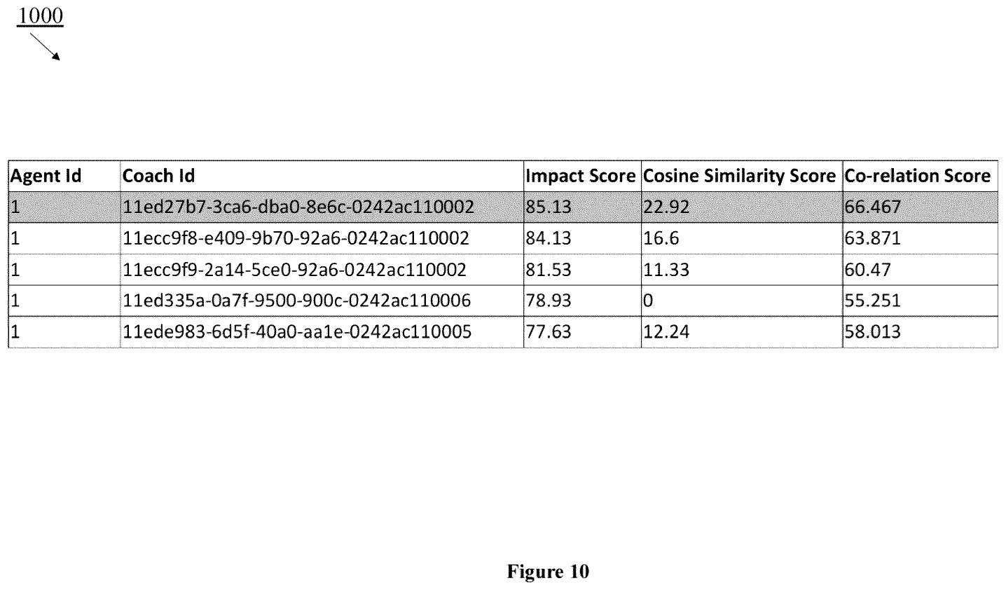

According to some embodiments of the present disclosure, for a selected focus area and related behavior and an agent having an agentid ‘1’, the coach impact score, cosine similarity score and correlational score may be for example, as shown in table 1000 in FIG. 10. The agent having the highest correlational score may be the most effective coach for the agent for the selected focus area and related behavior. A new coaching session for the selected focus area and related behaviors may be created in system 100B with a coach having the highest correlational score.

FIGS. 2A-2C schematically illustrates a high-level diagram of a computerized-method 200 for enhancing effectiveness of a coaching session of an agent by creating the coaching session based on a calculated coach impact score of coaches, in a contact center, in accordance with some embodiments of the present invention;

According to some embodiments of the present disclosure, operation 210 comprising receiving coaching feedback data via a coaching web application from the agent after each coaching session that the agent has participated in. The coaching feedback data is about the coaching session and a related coach.

According to some embodiments of the present disclosure, operation 220 comprising receiving a request from a user, via a User Interface (UI) that is associated to the coaching web application, to create a new coaching session to the agent for a selected focus area and related behaviors.

According to some embodiments of the present disclosure, operation 230 comprising collecting the coaching feedback data that has been received from the agent for a plurality of coaching sessions that have been conducted during a preconfigured period. The collected feedback data includes for each coaching session at least one of: (a) set of coaching ratings; and (b) coaching comment, and each coaching session in the plurality of coaching sessions has been conducted by a different coach.

According to some embodiments of the present disclosure, operation 240 comprising filtering bias from the coaching feedback data by removing bias therefrom to yield filtered coaching feedback data.

According to some embodiments of the present disclosure, operation 250 comprising operating a coach evaluation module based on the filtered coaching feedback data, to yield an effective-feedback score, an associated dynamic weightage, and a coaching effectiveness score for each coach for the selected focus area and related behavior during the preconfigured period.

According to some embodiments of the present disclosure, operation 260 comprising calculating a coach impact score for each coach in the plurality of coaches by operating a coaching impact score module on the yielded effective-feedback score, the associated dynamic weightage, and the coaching effectiveness score of the coach.

According to some embodiments of the present disclosure, operation 270 configuring the UI that is associated to the coaching application to selectively display a subset of the plurality of coaches based on the calculated coach impact score of each coach in the plurality of coaches. The subset of coaches includes a preconfigured number of coaches having the highest calculated coach impact score, and the calculated coach impact score of each coach indicates effectiveness-level of the coach to the new coaching session.

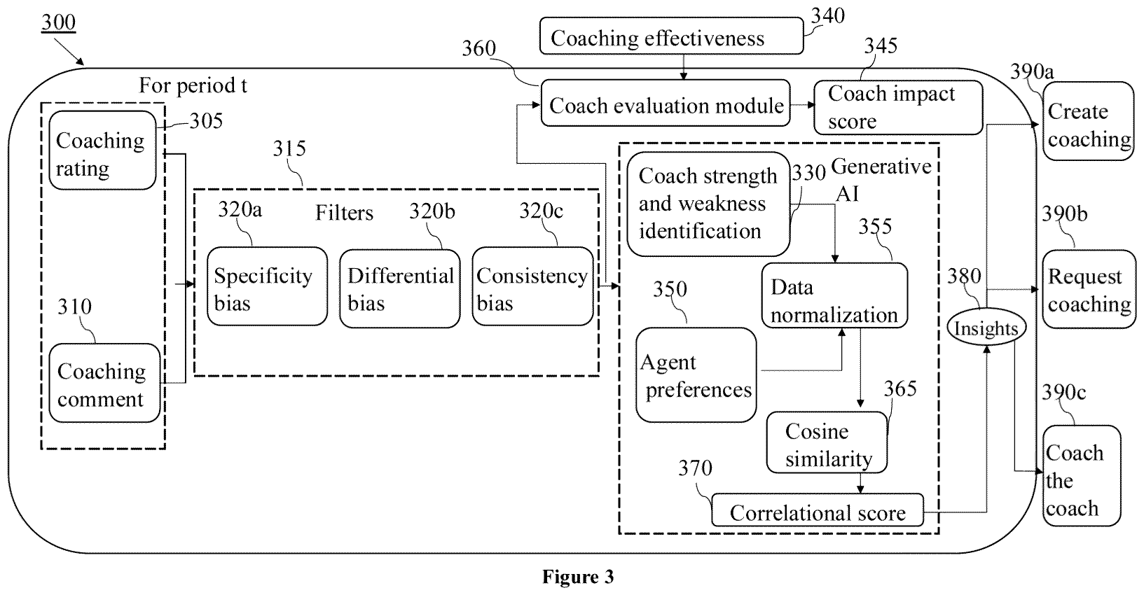

FIG. 3 schematically illustrates a high-level diagram 300 of a system for enhancing effectiveness of a coaching session of an agent by creating the coaching session based on a calculated coach impact score of coaches, in a contact center, in accordance with some embodiments of the present invention.

According to some embodiments of the present disclosure, upon receiving a request from a user, via a User Interface that is associated to a coaching web application, to create a new coaching session for an agent, for example, as shown in system 100B in FIG. 1, the coaching feedback data that has been received from the agent for a plurality of coaching sessions after a plurality of coaching sessions that have been conducted during a preconfigured period for the agent, may be fetched.

According to some embodiments of the present disclosure, coaching feedback data that has been received from the agent for a plurality of coaching sessions, for the selected focus area and related behavior, that have been conducted during a preconfigured period, may be collected. The collected feedback data may include for each coaching session at least one of: (a) set of coaching ratings; and (b) coaching comment, and each coaching session in the plurality of coaching sessions has been conducted by a different coach.

According to some embodiments of the present disclosure, the coaching feedback data may include: (a) set of coaching ratings 305; and (b) coaching comment 310 for every coaching session. The set of coaching rating is the rating given by the agent to the coaching session once the coaching session has been acknowledged by the agent. The coaching comment is a verbal feedback about the session and the coach which is captured in the coaching comment while the agent is acknowledging the coaching session.

According to some embodiments of the present disclosure, the coaching feedback data may include outliers, biased feedback, and missing details, hence the coaching feedback data has to be filtered and enriched. The differential bias filter 320b may identify misalignment between comment and rating and then may replace the rating value to align with the comment. Biases, such as specificity bias 320a, differential bias 320b and consistency bias 320c may be removed from the coaching feedback data by filters 315. Specificity bias 320a may be in the coaching feedback data when the comments are not specific enough. A filter may be applied on the coaching feedback data, such that only coaching comments in the coaching feedback data that are specific enough may be considered in the proceeding processes of calculating the coach impact score and correlational score. A filter may be applied on the coaching feedback data, such that differential bias may be removed. Differential bias 320b in the coaching feedback data may be when a user knowingly or unknowingly provides a good feedback in the comments section but low rating in the set of coaching rating. For example, the rating of ‘2’ out of ‘5’ provided with the following comment “The coaching session on acknowledgment was very informative and provided me with practical tips for improving my customer service skills.”

According to some embodiments of the present disclosure, a filter may be applied on the coaching feedback data, to remove consistency bias. Consistency bias 320c may be in the coaching feedback data when a user provides the same rating to all questions in the feedback. This bias may be also filtered.

According to some embodiments of the present disclosure, for each coach in the plurality of coaches that conducted the plurality of coaching sessions during a preconfigured period, the coach evaluation module, such as coach evaluation module 160b in FIG. 1, and such as coach evaluation module 360, may calculate an effective feedback score and calculate an associated dynamic weightage for the coach, and retrieve a coaching effectiveness score for each coach for the selected focus area and related behavior during the preconfigured period.

According to some embodiments of the present disclosure, the coach evaluation module 360 may consume the filtered coaching feedback data and may calculate an effective-feedback score for each coach for the selected focus area and related behavior combination by normalizing comments and ratings scores, and calculate an associated dynamic weightage, and also retrieve a coaching effectiveness score 340 from coaching effectiveness 340 for each coach for the selected focus area and related behavior during the preconfigured period.

According to some embodiments of the present disclosure, the coaching evaluation module 360 may operate on the filtered coaching feedback data to yield the effective-feedback score for each coach in the plurality of coaches. Based on the dynamic weightage that is derived for each effectiveness-feedback score, the remaining weightage e.g., out of 100 may be considered for the coaching effective score to derive the coach impact score 345. For example, as shown in FIG. 14.

According to some embodiments of the present disclosure, the coach impact score may be calculated according to formula II:

coach impact score=(dynamic weightage*effective-feedback score)+((100−dynamic weightage)*coaching effectiveness score) (II)

whereby:
the dynamic weightage is the calculated dynamic weightage for the effective-feedback score, the effective-feedback score is the effective feedback score yielded by the coach evaluation module, and the coaching effectiveness score is a score that is retrieved from the database by the coach evaluation module for each coach for the selected focus area and related behavior during the preconfigured period.

According to some embodiments of the present disclosure, insights 380 may be provided, such as a preconfigured number of coaches having highest coach impact score based on identified preconfigured number of coaches having highest coach impact score from the plurality of coaches for the selected focus area and related behavior. For example, as shown in FIG. 14. The correlational score 370 may be based on a cosine similarity score 365 which may be calculated between coach-vector which represents the coaches strengths and weaknesses and between agent-vector which represents the agent's preferences.

According to some embodiments of the present disclosure, the coach-vector may be generated based on a textual-summary of strengths and weaknesses of the coach 330. The textual-summary of strengths and weaknesses of each coach in the plurality of coaches may be created by operating a Generative Artificial Intelligence (AI) with LLM with a prompt-text on the filtered coaching feedback data, which is the coaching comment 310 and the coaching rating 305 after the filters 315 have been applied. The Gen AI may be implemented with Large Language Model (LLM), for example, via Azure® OpenAI Application Programming Interfaces (API) s.

According to some embodiments of the present disclosure, the agent-vector may be generated based on a textual-summary of agent's preferences 350. The textual-summary of agent's preferences may be created by operating a Generative AI on the filtered coaching feedback data which is the coaching comment 310 and the coaching rating 305 after the filters 315 have been applied.

According to some embodiments of the present disclosure, the text-summary of the coach's strengths and weaknesses and the text-summary of the agent's preferences then may be further normalized 355 to numerical values with Euclidean norm to represent two vectors: agent-vector that represents the agent's preferences and coach-vector that represents the coach's strengths and weaknesses. For example, by using Term Frequency-Inverse Document Frequency (TF_IDF) or Bag of words (BoW) model. The text-summary of the coach's strengths and weaknesses and the text-summary of the agent's preferences then may be normalized to numerical values by any other suitable method.

According to some embodiments of the present disclosure, the agent-vector may be paired with each coach-vector of the coaches. Then, a cosine similarity score 365 may be derived for each agent-vector and coach-vector. Optionally, a cosine similarity score may be derived between the agent-vector and coach vector of a preconfigured number of coaches having highest coach impact score.

According to some embodiments of the present disclosure, a correlation score module 370 may be operated to calculate a correlation score between the agent's preferences and coach impact score to provide the most impactful coaches which are aligning with the agent's preferences.

According to some embodiments of the present disclosure, insights 380, such as the coach impact score of each coach in the plurality of coaches and the calculated correlation score for each coach with the agent's preferences, may be used to take the following actions: (i) create a new coaching session 390a; (ii) delegate a coaching session; (iii) serve a request for a coaching session 390b; and (iv) create a coach the coach training session 390c.

According to some embodiments of the present disclosure, the created new coaching session for the agent may be scheduled with the coach having the highest calculated coach impact score or highest calculated correlation score. Also, a coach may delegate a scheduled coaching session to another coach having the highest calculated coach impact score or highest calculated correlation score.

According to some embodiments of the present disclosure, when an agent requests a coaching session for a focus area and behavior a new coaching session may be created with a coach having the highest calculated coach impact score or highest calculated correlation score.

According to some embodiments of the present disclosure, the calculated coach impact score may be used to identify a preconfigured number of coaches having the lowest coach impact score for a coach the coach training session to improve their coach impact score for the focus area and related behavior.

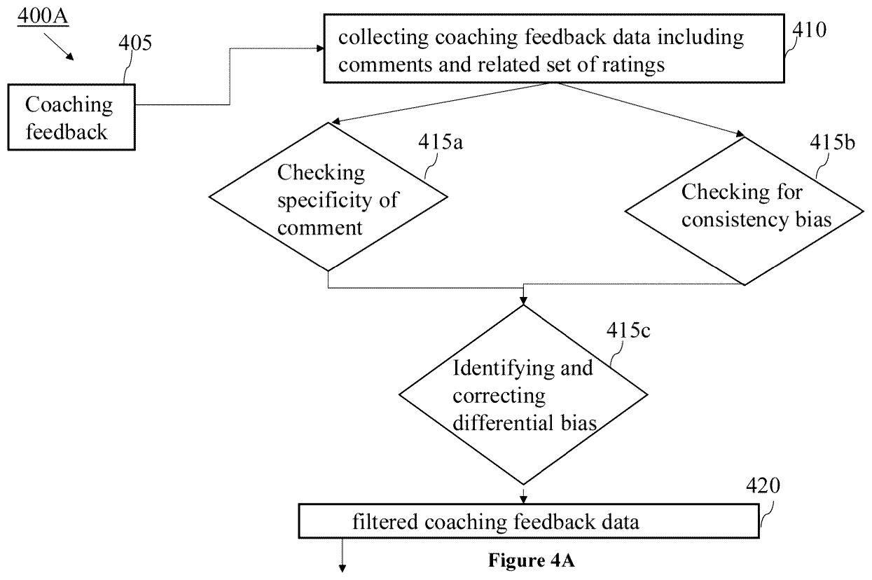

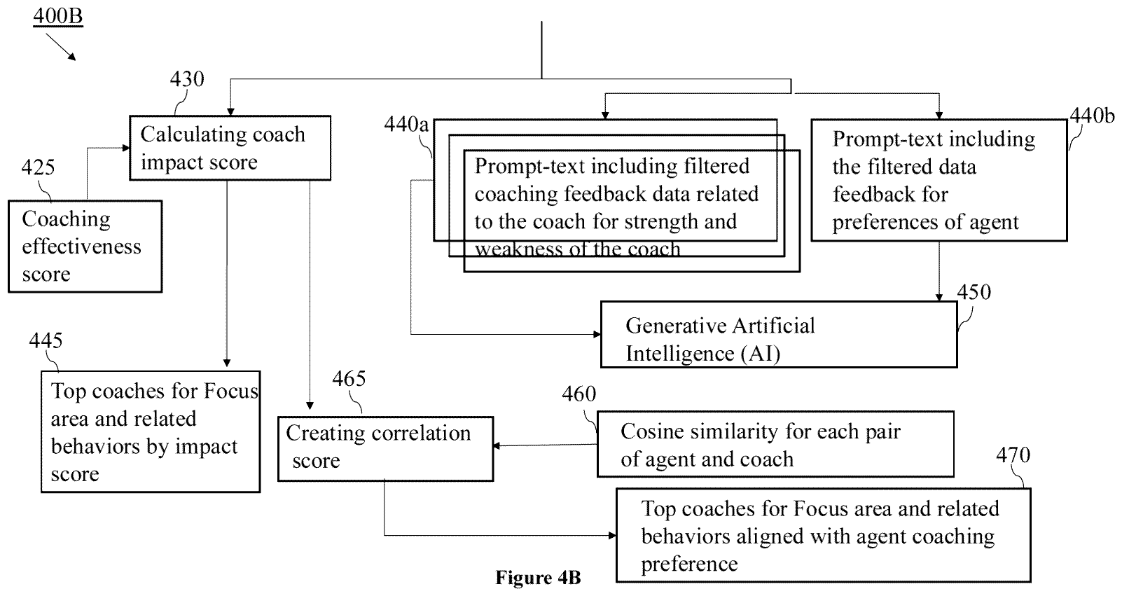

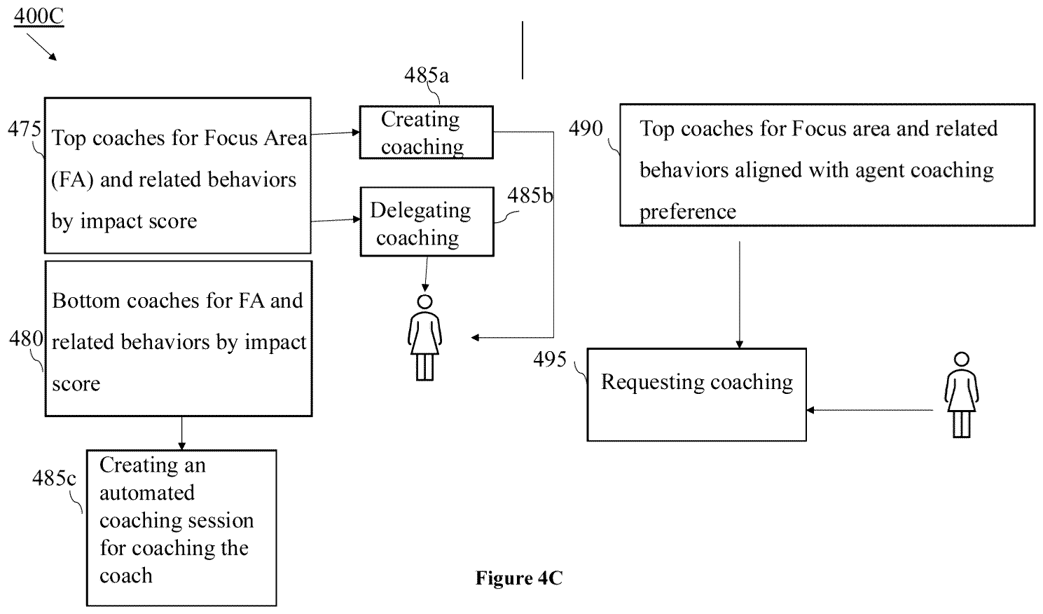

FIG. 4A-4C schematically illustrates a high-level diagram 400 of a computerized-method for enhancing effectiveness of a coaching session of an agent by creating the coaching session based on a calculated coach impact score of coaches, in a contact center, in accordance with some embodiments of the present invention.

According to some embodiments of the present disclosure, in a system, such as system 100B for enhancing effectiveness of a coaching session of an agent by creating the coaching session based on a calculated coach impact score of coaches, in a contact center, collecting coaching feedback data including comments and related set of ratings 410. The coaching feedback data 405 that has been from the agent for previous coaching sessions for the selected focus area and related behavior may be fetched from a coaching service, such as coaching MS 115b in FIG. 1B, for period t. The coaching feedback data may include coaching ratings, such as coaching rating 305 in FIG. 3, which is the rating given by the agent to the coaching session once the session has been acknowledged by the agent. The coaching feedback data may also include coaching comment, such as coaching comment 310 in FIG. 3, which is a verbal feedback about session that the agent can provide while acknowledging the session and coach which is captured in a coaching comment.

According to some embodiments of the present disclosure, when the coaching feedback data is collected it may include outliers, biased coaching feedback data and missing details, hence it has to be filtered and enriched. A coaching session with outliers or missing details may be a session with no comments, no ratings or both absent.

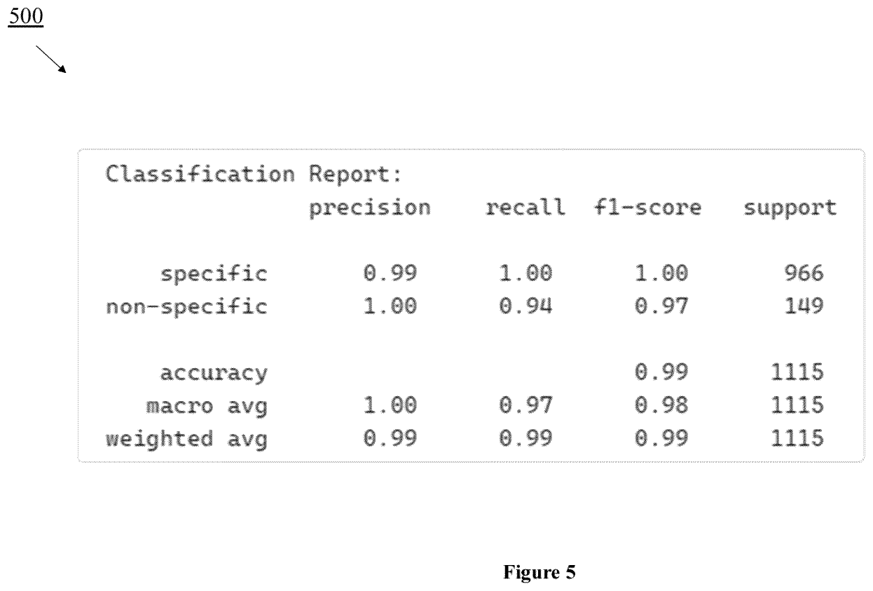

According to some embodiments of the present disclosure, the biased coaching feedback data may be removed by checking specificity of comment 415a and checking for consistency bias 415b. The specificity bias may include the comments which are not specific enough such that after it is removed only comments which are specific enough may be processed. The specificity bias may be identified by using the Naïve Bayes classifier to create a confusion matrix. For example, a classification report, as shown in FIG. 5.

According to some embodiments of the present disclosure, the differential bias may be identified and corrected 415c. Sometimes an agent, knowingly or unknowingly, provides a good feedback comment but gives low rating, which results in a differential bias in the coaching feedback data. For example, for the comment “The coaching session on acknowledgment was very informative and provided me with practical tips for improving my customer service skills.” The rating given is ‘2’ out of ‘5’.

According to some embodiments of the present disclosure, to identify and correct differential bias a transformer model, such as distilbert-base-uncased-finetuned-sst-2-english may be used for classifying feedback comments based on their identified sentiments. If there is a significant variance observed between the comment and the set of ratings then, the average numeric rating may be corrected to reduce this variance, thus giving more significance to the feedback comment.

According to some embodiments of the present disclosure, the consistency bias may occur when users give ratings like 1,1,1 or 2,2,2. To remove this bias, the aggregated percentage for each rating value for each user is considered. The past rating pattern is observed for the agent and the average rating value for past ratings to each rating value may be calculated. If current rating observed to be in same pattern of the aggregated rating value, then its considered as a bias. For example, when an agent past trend suggests-rating ‘1’—75.86%, rating ‘2’—17.23%, rating ‘3’—6.94% and current rating is ‘1’ it means that the agent is biased towards giving ‘1’, i.e., if the biased rating falls under the highest percentage value, then it's considered as bias.

According to some embodiments of the present disclosure, the filtered coaching feedback data 420 may be provided to a coaching evaluation module, such as coaching evaluation module 160b and such as coaching evaluation module 360 in FIG. 3.

According to some embodiments of the present disclosure, the coach evaluation module may consume the filtered coaching feedback data and may calculate an effective-feedback score, an associated dynamic weightage, and a coaching effective score for each coach for the selected focus area and related behavior, during the preconfigured period.

According to some embodiments of the present disclosure, for the calculation of the effective-feedback score, the coach evaluation module may create an average-normalized comment score and an average-normalized rating. The effective-feedback score may be calculated according to formula I:

effective-feedback score=(preconfigured-weight-comment*average-normalized-comment score)+(preconfigured-weight-rating*average-normalized-rating) (I)

whereby:
the preconfigured-weight comment is a preconfigured weight that has been assigned to the average-normalized-comment score,
the average-normalized-comment score is the created average-normalized comment score, the preconfigured-weight-rating is a preconfigured weight that has been assigned to the average-normalized-ratings, and the average-normalized-rating is the created average-normalized rating.

According to some embodiments of the present disclosure, an average-normalized comment score may be created by analyzing all the coaching comments in the filtered coaching feedback data with a sentiment intensify analyzer to yield a compound score of the comment sentiment in each coaching comment. To convert a negative compound score of a coaching comment to a positive scale, the compound score is averaged by adding 1. For example, commentSentimentScore=(CommentCompoundScore+1)/2

According to some embodiments of the present disclosure, the comment sentiment score may be then normalized to the range of ‘100’ with a minimum value of ‘1’ and a maximum value of ‘100’. The rating range may be calculated by the formula: rating range=maximum value −minimum value, and the normalized comment score may be calculated by:

normalized comment score=round(comment sentiment score*ratine range+minimum range).

According to some embodiments of the present disclosure, the average-normalized-comment score may be calculated for a coach for the selected focus area and related behavior.

According to some embodiments of the present disclosure, for example, when the scale of rating is in the range of ‘0’ to ‘5’ an average-normalized rating may be created by: (i) for each set of coaching ratings in the collected feedback data that is related to a coaching session that is related to the coach, calculating an average of ratings in the set of coaching ratings to yield a rating-score and storing it in a rating-datastore; (ii) calculating an average of all rating scores in the rating-datastore which are related to the coach to yield an average-ratings score; and (iii) converting the calculated average-ratings score to a preconfigured scale to yield the average-normalized rating. For example, the scale may be a scale of ‘0’ to ‘100’ such that the average-normalized rating is calculated as follows:

average-normalized rating=round(((average-rating score/100)*5),1).

According to some embodiments of the present disclosure, the effective-feedback score for each coach may be calculated according to formula I:

effective-feedback score=(preconfigured-weight-comment*average-normalized-comment score)+(preconfigured-weight-rating*average-normalized-rating) (I)

whereby:
the preconfigured-weight comment is a preconfigured weight that has been assigned to the average-normalized-comment score, it denotes weightage to be given to comment score out of 100 for example, 60,
the average-normalized-comment score is the created average-normalized comment score, it denotes a normalized comment score for a coach for the selected focus area and related behavior, the preconfigured-weight-rating is a preconfigured weight that has been assigned to the average-normalized-rating, it denotes weightage to be given to ratings score which will be 100-preconfigured-weight-comment, for example, 100−60=40 and
the average-normalized-rating is the created average-normalized rating, it denotes normalized ratings score for a coach for the selected focus area and related behavior.

According to some embodiments of the present disclosure, the coaching effectiveness score 425 may be retrieved for each coaching session.

According to some embodiments of the present disclosure, a dynamic weightage for the effective-feedback score may be calculated by: (i) determining a first-number of coaching sessions in the plurality of coaching sessions, for example, 10 coaching sessions; (ii) determining a second-number of coaching sessions in the plurality of coaching sessions that were conducted by a coach that has conducted the coaching session, for example 6 coaching sessions, and (iii) calculating a dynamic weightage for the effective-feedback score by dividing the second-number of coaching sessions by the first-number of coaching sessions, for example 6/10-0.6.

According to some embodiments of the present disclosure, the coaching impact score module, such as coach impact analytics 145b in FIG. 1B and such as coach impact score 345 in FIG. 3, may calculate a coach impact score 430 based on the dynamic weightage that has been calculated for the effective-feedback score by the coach evaluation module and coaching effectiveness score 425 which has been retrieved and calculated for the coach. For example, as shown in FIG. 14. The coach impact score may be calculated for each coach in the plurality of coaching sessions, according to formula II:

coach impact score=(dynamic weightage*effective-feedback score)+((100−dynamic weightage)*coaching effectiveness score)

whereby:
the dynamic weightage is the calculated dynamic weightage for the effective-feedback score, the effective-feedback score is the effective feedback score yielded by the coach evaluation module, and the coaching effectiveness score is a score that is retrieved from the database by the coach evaluation module for each coach for the selected focus area and related behavior during the preconfigured period. The score is calculated based on coaching session feedback comments and ratings of past coaching sessions of the agent for the selected focus area and related behavior.

According to some embodiments of the present disclosure, the coach impact score denotes the impact that the coach has for conducting coaching session with the selected focus area and related behavior and the effectiveness that the coach can bring to the coaching sessions with the agent.

According to some embodiments of the present disclosure, top coaches for the selected focus area and related behaviors may be identified 445 based on the coach impact score.

According to some embodiments of the present disclosure, prompt-text including filtered data feedback related to the coach for strength and weakness of the coach 440a may be provided to a Generative Artificial Intelligence (AI) with LLM 450 to yield a text-summary of strengths and weaknesses of each coach in the plurality of coaching sessions. For example, as shown in FIG. 6.

According to some embodiments of the present disclosure, prompt-text including the filtered data feedback for preferences of agent 440b may be provided to the Generative AI 450 to create a textual summary of agent's preferences. For example, as shown in FIG. 7.

According to some embodiments of the present disclosure, the created textual-summary of strengths and weaknesses of each coach in the plurality of coaches may be normalized into numerical values with Euclidean norm to represent coach-vector and the created textual-summary of preferences of the agent may be normalized into numerical values with Euclidean norm to represent to represent agent-vector. The textual-summary may be normalized by using for example, TF_IDF or BoW model.

According to some embodiments of the present disclosure, the agent-vector may be paired with each coach-vector of the coaches, for example, as shown in FIG. 8. Then, a cosine similarity score 460 may be derived for each agent-vector and coach-vector. Optionally, a cosine similarity score may be derived only between the agent-vector and coach-vector of a preconfigured number of coaches having highest coach impact score.

According to some embodiments of the present disclosure, a correlation score 465 between the agent's preferences and coach impact score may be calculated to provide the most impactful coaches which are aligning with the agent's preferences, i.e., top coaches for focus area and related behaviors aligned with agent coaching preference 470. For example, as shown in FIG. 10.

According to some embodiments of the present disclosure, the cosine similarity score may be calculated by using sklearn.metrics module. For example, as shown in FIG. 9.

According to some embodiments of the present disclosure, the calculating of the correlational score may be performed by formula III:

correlational score=(weight_cosine_similarity*cosine similarity score)+(weight_coach_impact_score+coach impact score), (III)

whereby:
weight_cosine_similarity is a preconfigured weightage for cosine similarity score consideration, out of 100, for example, 30.
cosine_similarity_score is a score for agent's preferences and coach's strengths and weaknesses, weight_coach_impact_score is a preconfigured weightage for coach impact score. For example, 100−the weight_cosine_similarity, for example, 70.

According to some embodiments of the present disclosure, the insights based on the coach impact score may be generated for the selected focus area and behavior. A high coach impact score, e.g., above a preconfigured threshold, indicates that the coach may be more impactful for coaching sessions for the agent. Top coaches for Focus Area (FA) and related behaviors by coach impact score 475 may be identified for creating coaching 485a or delegating coaching 485b.

According to some embodiments of the present disclosure, based on the coach impact score, a configurable number of coaches may be identified for the selected focus area and related behavior, for the agent. Optionally, a new coaching session may be automatically created to the agent with the coach having the highest coach impact score.

According to some embodiments of the present disclosure, based on the coach impact score, a coach may use a list of coaches with related coach impact score to delegate a coaching session of the agent to another coach by selecting the coach with the highest coach impact score. Optionally, the coaching session of the coach may be automatically delegated to the coach having the highest coach impact score.

According to some embodiments of the present disclosure, insights may be based also on the correlation score as to impactful coach who also aligns with agent's preferences. Thus, enabling a selection of a coach or creating a new session with a coach for an effective coaching session for the agent. Top coaches for the selected focus area and related behaviors aligned with agent coaching preference 490 may be identified. Optionally, a new coaching session may be automatically created to the agent with the coach having the highest correlational score.

According to some embodiments of the present disclosure, bottom coaches for FA and related behaviors by coach impact score 480, i.e., a preconfigured number of coaches having the lowest coach impact score may be selected for a coaching session of coaching the coach by creating automated coaching session for coaching the coach 485c.

According to some embodiments of the present disclosure, upon n agent requesting coaching 495 a new coaching session may be created based on the selected focus area related behavior and the calculated correlation score.

FIG. 5 is an example of a classification report 500, in accordance with some embodiments of the present invention.

According to some embodiments of the present disclosure, specificity bias may be removed from coaching feedback data by using the Naïve Bayes classifier to create a confusion matrix for identification of specificity bias in the coaching comments.

FIG. 6 is an example of a textual summary 600 of strengths and weaknesses of a coach, in accordance with some embodiments of the present invention.

According to some embodiments of the present disclosure, the filtered coaching comments, and ratings, i.e., filtered coaching feedback data may be provided to Generative AI with LLM to determine strengths and weaknesses of a coach. The Generative AI may create a textual summary of strengths and weaknesses of the coach based on the following prompt-text. prompt=“Please analyze the following coaching feedbacks and derive the strengths and weaknesses. Give these attributes in one word. Consolidate all the strengths and weakness and give Only list of top 3 values of each category. If there are no values on any category print NA once. Also don't number the strengths and weaknesses. They should be pipe separated: \n\n”.

FIG. 7 is an example of a textual summary of agent's preference to get coached, in accordance with some embodiments of the present invention.

According to some embodiments of the present disclosure, a textual-summary of preferences of the agent may be created by operating a Generative AI on the filtered coaching feedback data. The coaching session may be created for one or more agents. The preferences shown in the example relate to each agent that is participating in the new coaching session.

FIG. 10 is an example 1000 of impact score, cosine similarity score and correlational score of an agent with each coach in a plurality of coaches, in accordance with some embodiments of the present invention.

According to some embodiments of the present disclosure, for the agent with agentid ‘1’ the coach with Id 11ed27b7-3ca6-dba0-8e6c-0242ac110002 has highest correlational score and hence can be a good fit for the agent for the selected focus area and related behavior.

FIG. 11 is an example 1100 of feedback and ratings associated with the coach given by agents for particular coaching sessions, in accordance with some embodiments of the present invention.

According to some embodiments of the present disclosure, when the coaching session is conducted by the coach, upon completion each agent, e.g., an agent from agentid ‘1’-‘5’ provides a rating and feedback, e.g., coaching comment to the coach and the coaching session.

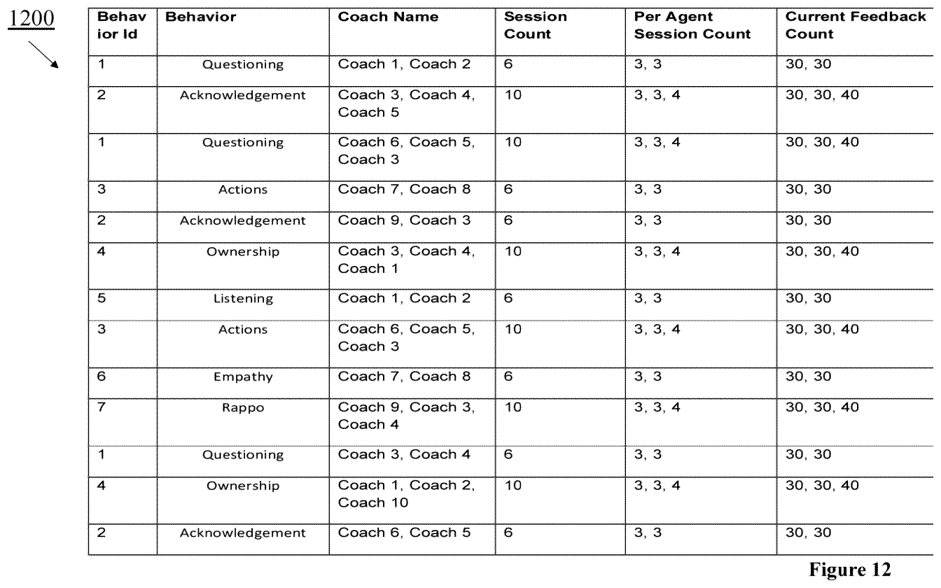

FIG. 12 is an example of a list of coaches and related calculated coach impact score and effectiveness score for a selected focus area and related behavior, in accordance with some embodiments of the present invention.

According to some embodiments of the present disclosure, the list of coaches includes each coach in the plurality of coaches in the plurality of coaching sessions that have been conducted during a preconfigured period for the agent for the selected focus area and related behavior. The coach impact score may be calculated by operating a coaching impact score module on the yielded effective-feedback score, the associated dynamic weightage, and the coaching effectiveness score of the coach.

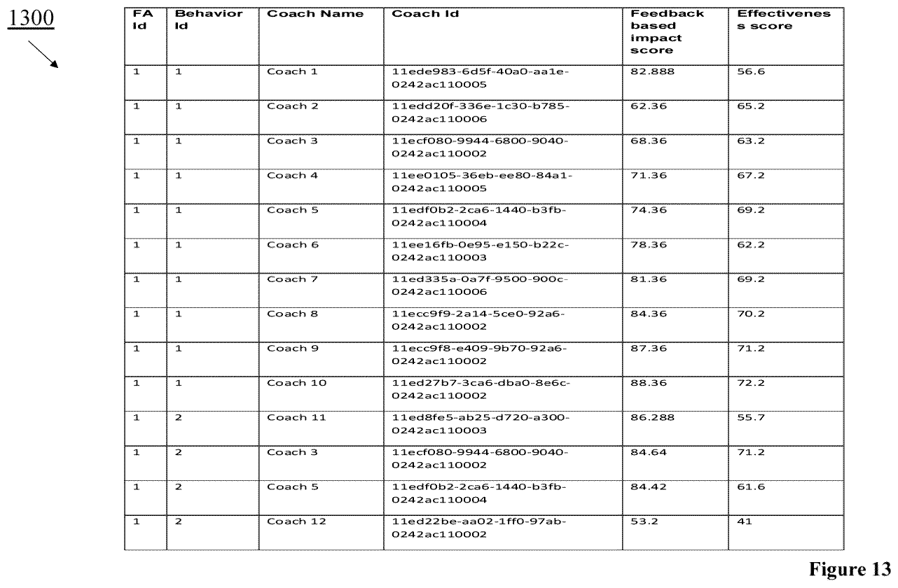

FIG. 13 is an example of the feedback and effectiveness score, in accordance with some embodiments of the present invention.

According to some embodiments of the present disclosure, the Feedback score is calculated using the rating and feedback comments as shown in FIG. 1B and FIG. 3. The effectiveness score for each coach that has conducted a coaching session for the agent that a new coaching session is being created for the selected focus area and related behavior during a preconfigured period. The coaching effectiveness score has been calculated by a module, such as coaching effectiveness calculation job 140b in FIG. 1B, which may run daily for each coaching session. This coaching effectiveness calculation job 140b in FIG. 1B consumes data from coaching MS 115b in FIG. 1B for each coaching session related focus areas and behaviors and calculates a coaching effectiveness score for each coaching session based on metric performance improvement. The coaching effectiveness calculation job 140b in FIG. 1B may be implemented for example, as described in detail in U.S. Pat. No. 11,403,579 B2. Based on the calculated coaching effectiveness score of each coaching session, a coaching effectiveness score for each coach may be calculated for the selected focus area and related behavior during the preconfigured period.

FIG. 15 is an example of agent preferences, in accordance with some embodiments of the present invention.

According to some embodiments of the present disclosure, the agent preferences have been extracted from the textual-summary of preferences of the agent that has been created by operating a Generative AI on the filtered coaching feedback data, as shown in FIG. 7.

FIG. 16 is an example of a User Interface (UI) 1600 to create a new coaching session based on a calculated coach impact score, in accordance with some embodiments of the present invention.

According to some embodiments of the present disclosure, the impact score may be calculated for each coach-focus area-behavior combination. UI 1600 may be displayed during coaching creation, when the creator selects participants and then selects or changes focus area and related behavior.

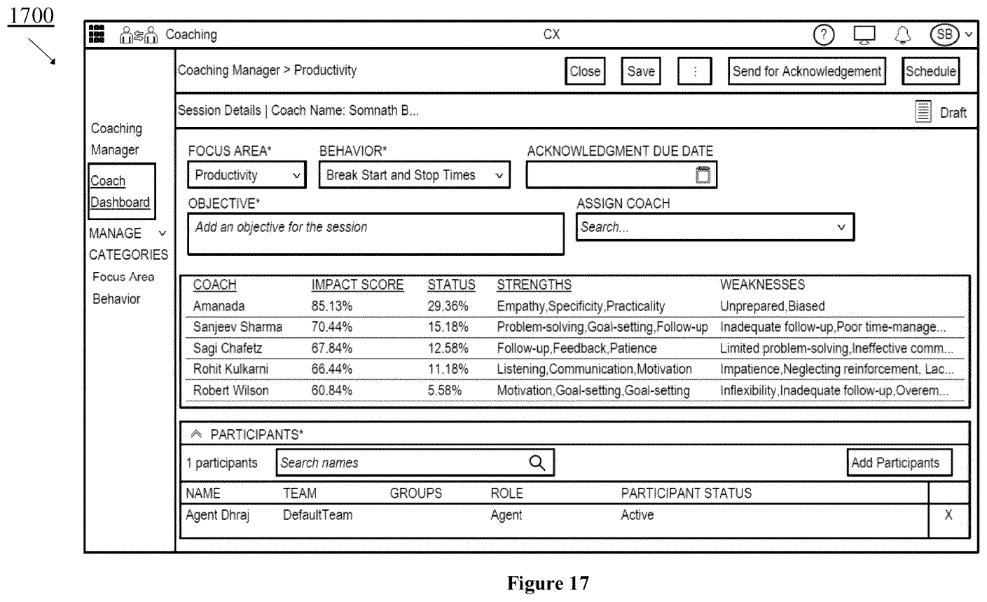

FIG. 17 is an example 1700 of a coach dashboard presenting coach impact score and strengths and weaknesses, in accordance with some embodiments of the present invention.

According to some embodiments of the present disclosure, in a system, such as system 100B in FIG. 1B, upon a request from a user, via a User Interface (UI) that is associated to the coaching web application, such as coaching web application 110b in FIG. 1B to create a new coaching session to the agent for the selected focus area and related behaviors, the UI that is associated to the coaching web application, such as coaching web application 110b in FIG. 1B, may be configured to selectively display a subset of the plurality of coaches based on the calculated coach impact score of each coach in the plurality of coaches. The subset of coaches includes a preconfigured number of coaches having the highest calculated coach impact score. The calculated coach impact score of each coach indicates an effectiveness-level of the coach to the new coaching session.

It should be understood with respect to any flowchart referenced herein that the division of the illustrated method into discrete operations represented by blocks of the flowchart has been selected for convenience and clarity only. Alternative division of the illustrated method into discrete operations is possible with equivalent results. Such alternative division of the illustrated method into discrete operations should be understood as representing other embodiments of the illustrated method.

Similarly, it should be understood that, unless indicated otherwise, the illustrated order of execution of the operations represented by blocks of any flowchart referenced herein has been selected for convenience and clarity only. Operations of the illustrated method may be executed in an alternative order, or concurrently, with equivalent results. Such reordering of operations of the illustrated method should be understood as representing other embodiments of the illustrated method.

Different embodiments are disclosed herein. Features of certain embodiments may be combined with features of other embodiments; thus, certain embodiments may be combinations of features of multiple embodiments. The foregoing description of the embodiments of the disclosure has been presented for the purposes of illustration and description. It is not intended to be exhaustive or to limit the disclosure to the precise form disclosed. It should be appreciated by persons skilled in the art that many modifications, variations, substitutions, changes, and equivalents are possible in light of the above teaching. It is, therefore, to be understood that the appended claims are intended to cover all such modifications and changes as fall within the true spirit of the disclosure.

While certain features of the disclosure have been illustrated and described herein, many modifications, substitutions, changes, and equivalents will now occur to those of ordinary skill in the art. It is, therefore, to be understood that the appended claims are intended to cover all such modifications and changes as fall within the true spirit of the disclosure.

What is claimed:

1. A computerized-method for enhancing effectiveness of a coaching session of an agent by creating the coaching session based on a calculated coach impact score of coaches, in a contact center, said computerized-method comprising:
(i) receiving coaching feedback data via a coaching web application from the agent after each coaching session that the agent has participated in,
wherein the coaching feedback data is about the coaching session and a related coach;
(ii) receiving a request from a user, via a User Interface (UI) that is associated to the coaching web application, to create a new coaching session to the agent for a selected focus area and related behaviors;
(iii) collecting the coaching feedback data that has been received from the agent for a plurality of coaching sessions that have been conducted during a preconfigured period,
wherein the collected feedback data comprising for each coaching session at least one of: (a) set of coaching ratings; and (b) coaching comment, and
wherein each coaching session in the plurality of coaching sessions has been conducted by a different coach;
(iv) filtering bias from the coaching feedback data by removing bias therefrom to yield filtered coaching feedback data;
(v) operating a coach evaluation module based on the filtered coaching feedback data, to yield an effective-feedback score an associated dynamic weightage, and a coaching effectiveness score for each coach for the selected focus area and related behavior during the preconfigured period;
(vi) calculating a coach impact score for each coach in the plurality of coaches by operating a coaching impact score module on the yielded effective-feedback score, the associated dynamic weightage, and the coaching effectiveness score of the coach; and
(vii) configuring the UI that is associated to the coaching application to selectively display a subset of the plurality of coaches based on the calculated coach impact score of each coach in the plurality of coaches,
wherein the subset of coaches includes a preconfigured number of coaches having the highest calculated coach impact score, and
wherein the calculated coach impact score of each coach indicates an effectiveness-level of the coach to the new coaching session.

2. The computerized-method of claim 1, wherein the set of coaching rating and the coaching comment have been provided by the agent when the coaching session has been acknowledged by the agent.

3. The computerized-method of claim 2, wherein the bias that is removed from the collected coaching feedback data comprising at least one of: (i) specificity bias that includes comments which are not specific to the coaching session; (ii) differential bias that includes comment and related set of ratings that are not consistent; and (iii) consistency bias that includes same value for all ratings in the set of ratings.

4. The computerized-method of claim 1, wherein the computerized-method further comprising creating the new coaching session for the agent with a coach having highest coach impact score by operating a workflow service.

5. The computerized-method of claim 1, wherein the computerized-method further comprising: (i) creating a textual-summary of strengths and weaknesses of each coach in the plurality of coaches and a textual-summary of preferences of the agent by operating a Generative Artificial Intelligence (AI) on the filtered coaching feedback data; (ii) normalizing to numerical values with Euclidean norm of the created textual-summary of strengths and weaknesses of each coach in the plurality of coaches to represent coach-vector and the created textual-summary of preferences of the agent to represent agent-vector; (iii) pairing the agent-vector with each coach-vector of the coach; (iv) calculating a cosine similarity score for each pair of agent-vector and coach-vector; (v) calculating a correlational score for each coach in the plurality of coaches based on the respective calculated coach impact score and the respective calculated cosine similarity score,
wherein the calculated correlational score of each coach indicates a level to which the calculated coach impact score and agent behavioral preferences are aligned; and (vi) configuring the UI that is associated to the coaching application to selectively display a subset of the plurality of coaches based on the correlational score,
wherein the subset of coaches includes a preconfigured number of coaches having the highest calculated correlational score.

6. The computerized-method of claim 5, the computerized-method further comprising creating the new coaching session for the agent with a coach having highest correlational score by operating a workflow service.

7. The computerized-method of claim 1, wherein the computerized-method further comprising selecting a preconfigured number of coaches from the plurality of coaches having lowest coach impact score and creating a coach-the-coach training session for the selected preconfigured number of coaches to improve their coach impact score for the received focus area and related behaviors.

8. The computerized-method of claim 1, wherein the coach evaluation module comprising:
for each coach in the plurality of coaches:
(iii) creating an average-normalized comment score and an average-normalized rating;
(iv) calculating an effective-feedback score according to formula I:
effective-feedback score=(preconfigured-weight-comment*average-normalized-comment score)+(preconfigured-weight-rating*average-normalized-rating) (I)
whereby:
the preconfigured-weight comment is a preconfigured weight that has been assigned to the average-normalized-comment score,
the average-normalized-comment score is the created average-normalized comment score,
the preconfigured-weight-rating is a preconfigured weight that has been assigned to the average-normalized-rating,
the average-normalized-rating is the created average-normalized rating;
(v) retrieving a coaching effectiveness score for each coach for the selected focus area and related behavior during the preconfigured period from a database;
(vi) determining a first-number of coaching sessions in the plurality of coaching sessions;
(vii) determining a second-number of coaching sessions in the plurality of coaching sessions that were conducted by a coach that has conducted the coaching session, and
(viii) calculating a dynamic weightage for the effective-feedback score by dividing the second-number of coaching sessions by the first-number of coaching sessions.

9. The computerized-method of claim 8, wherein the creating of the average-normalized comment score for each coach comprising:
(i) for each coaching comment in the collected feedback data that is related to a coaching session that is related to the coach:
a. calculating a compound score of a sentiment of the coaching comment by operating a sentiment-intensity analyzer module on the coaching comment;
b. when the calculated compound score has a negative value, then converting the calculated compound score to positive scale by averaging a sum of the negative value and ‘1’; and
c. normalizing the compound score to a preconfigured rating-range to yield a normalized comment score and storing it in a comments-datastore, and
(ii) calculating an average of all the normalized comment scores in the comments-datastore which are related to the coach to yield the average-normalized comment score, and
wherein the creating of the average-normalized rating comprising:
(i) for each set of coaching ratings in the collected feedback data that is related to a coaching session that is related to the coach calculating an average of ratings in the set of coaching ratings to yield a rating-score and storing it in a rating-datastore;
(ii) calculating an average of all rating scores in the rating-datastore which are related to the coach to yield an average-ratings score; and
(iii) converting the calculated average-ratings score to a preconfigured scale to yield the average-normalized rating.

10. The computerized-method of claim 8, wherein the coaching impact score module comprising calculating the coach impact score for each coach in the plurality of coaches, according to formula II:
coach impact score=(dynamic weightage*effective-feedback score)+((100−dynamic weightage)*coaching effectiveness score) (II)
whereby:
the dynamic weightage is the calculated dynamic weightage for the effective-feedback score, the effective-feedback score is the effective feedback score yielded by the coach evaluation module, and
the coaching effectiveness score is a score that is retrieved from the database by the coach evaluation module for each coach for the selected focus area and related behavior during the preconfigured period.

11. A computerized-system for enhancing effectiveness of a coaching session of an agent by creating the coaching session based on a calculated coach impact score of coaches, in a contact center, said computerized-system comprising:
one or more processors; and
a coaching web application;
said one or more processors are configured to:
(i) receive coaching feedback data via the coaching web application from the agent after each coaching session that the agent has participated in,
wherein the coaching feedback data is about the coaching session and a related coach;
(ii) receive a request from a user, via a User Interface (UI) that is associated to the coaching web application, to create a new coaching session to the agent for a selected focus area and related behaviors;
(iii) collect the coaching feedback data that has been received from the agent for a plurality of coaching sessions that have been conducted during a preconfigured period,
wherein the collected feedback data comprising for each coaching session at least one of: (a) set of coaching ratings; and (b) coaching comment;
(iv) filter bias from the coaching feedback data by removing bias therefrom to yield filtered coaching feedback data;
(v) operate a coach evaluation module based on the filtered coaching feedback data, to yield an effective-feedback score, an associated dynamic weightage, and a coaching effectiveness score, for each coach for the selected focus area and related behavior during the preconfigured period;
(vi) calculate a coach impact score for each coach in the plurality of coaches by operating a coaching impact score module on the yielded effective-feedback score, the associated dynamic weightage, and the coaching effectiveness score of the coach; and
(vii) configure the UI that is associated to the coaching application to selectively display a subset of the plurality of coaches based on the calculated coach impact score of each coach in the plurality of coaches,
wherein the subset of coaches includes a preconfigured number of coaches having the highest calculated coach impact score, and
wherein the calculated coach impact score of each coach indicates effectiveness-level of the coach to the new coaching session.

12. The computerized-system of claim 11, wherein the set of coaching rating and the coaching comment have been provided by the agent when the coaching session has been acknowledged by the agent.

13. The computerized-system of claim 12, wherein the bias that is removed from the collected coaching feedback data comprising at least one of: (i) specificity bias that includes comments which are not specific; (ii) differential bias that includes comment and related set of ratings that are not consistent; and (iii) consistency bias that includes same value for all ratings in the set of ratings.

14. The computerized-system of claim 11, wherein the one or more processors are further configured to create the new coaching session for the agent with a coach having highest coach impact score by operating a workflow service.

15. The computerized-system of claim 11, wherein the one or more processors are configured to select a preconfigured number of coaches from the plurality of coaches having lowest coach impact score and to create a coach-the-coach training session for the selected preconfigured number of coaches to improve their coach impact score for the received focus area and related behaviors.

16. The computerized-system of claim 11, wherein the coach evaluation module comprising:
for each coach in the plurality of coaches:
(i) creating an average-normalized comment score and an average-normalized rating;
(ii) calculating an effective-feedback score according to formula I:
effective-feedback score=(preconfigured-weight-comment average-normalized-comment score)+(preconfigured-weight-rating*average-normalized-rating) (I)
whereby:
the preconfigured-weight comment is a preconfigured weight that has been assigned to the average-normalized-comment score,
the average-normalized normalized-comment score is the created average-normalized normalized comment score,
the preconfigured-weight-rating is a preconfigured weight that has been assigned to the average-normalized-rating, and
the average-normalized normalized-rating is the created average-normalized normalized rating,
(iii) retrieving a coaching effectiveness score for each coach for the selected focus area and related behavior during the preconfigured period from a database;
(iv) determining a first-number of coaching sessions in the plurality of coaching sessions;
(v) determining a second-number of coaching sessions in the plurality of coaching sessions that were conducted by a coach that has conducted the coaching session, and
(vi) calculating a dynamic weightage for the effective-feedback score by dividing the second-number of coaching sessions by the first-number of coaching sessions.

17. The computerized-system of claim 16, wherein the creating of the average-normalized comment score for each coach comprising:
(i) for each coaching comment in the collected feedback data that is related to a coaching session that is related to the coach:
a. calculating a compound score of a sentiment of the coaching comment by operating a sentiment-intensity analyzer module on the coaching comment;
b. when the calculated compound score has a negative value, then converting the calculated compound score to positive scale by averaging a sum of the negative value and ‘1’; and
c. normalizing the compound score to a preconfigured rating-range to yield a normalized comment score and storing it in a comments-datastore, and
(ii) calculating an average of all the normalized comment scores in the comments-datastore which are related to the coach to yield the average-normalized comment score, and
wherein the creating of the average-normalized rating comprising:
(i) for each set of coaching ratings in the collected feedback data that is related to a coaching session that is related to the coach
calculating an average of ratings in the set of coaching ratings to yield a rating-score and storing it in a rating-datastore;
(ii) calculating an average of all rating scores in the rating-datastore which are related to the coach to yield an average-ratings score; and
(iii) converting the calculated average-ratings score to a preconfigured scale to yield the average-normalized rating.

18. The computerized-system of claim 16, wherein the coaching impact score module comprising calculating the coach impact score for each coach in the plurality of coaches, according to formula II:
coach impact score=(dynamic weightage*effective-feedback score)+((100−dynamic weightage)*coaching effectiveness score) (II)
whereby:
the dynamic weightage is the calculated dynamic weightage for the effective-feedback score, the effective-feedback score is the effective feedback score yielded by the coach evaluation module, and
the coaching effectiveness score is a score that is retrieved from the database by the coach evaluation module for each coach for the selected focus area and related behavior during the preconfigured period.
